(19) United States
(12) Patent Application Publication
(10) Pub. No.: US 2026/0281335 A1
(43) Pub. Date: Sep. 17, 2026

(54) EFFICIENT LOOP RESTORATION FILTER DECISION MAKING IN VIDEO ENCODING

(71) Applicants: Minzhi Sun, Bellevue, WA (US); Ximin Zhang, San Jose, CA (US); Yi-Jen Chiu, San Jose, CA (US)

(72) Inventors: Minzhi Sun, Bellevue, WA (US); Ximin Zhang, San Jose, CA (US); Yi-Jen Chiu, San Jose, CA (US)

(21) Appl. No.: 19/664,437

(22) Filed: Apr. 30, 2026

(51) Int. Cl. H04N 19/117; H04N 19/172; H04N 19/186; H04N 19/46; H04N 19/82

(52) U.S. Cl. CPC H04N 19/117; H04N 19/172; H04N 19/186; H04N 19/46; H04N 19/82

(57) ABSTRACT

One or more techniques can be implemented to reduce loop restoration filter search complexity in video coding while maintaining coding efficiency. In one aspect, a frame is classified as an anchor frame or a non-anchor frame, and for non-anchor frames, a loop restoration filter search mode configuration is set based on a filter mode previously determined for an encoded anchor frame, thereby enabling inherited mode selection and avoiding redundant search. In another aspect, chroma plane filtering decisions are adaptively determined based on quantization parameters and color characteristics, enabling selection between frame-level and restoration-unit-level filtering. In a further aspect, loop restoration search for luma planes is constrained to frame-level filtering. The one or more techniques can reduce computational complexity while maintaining coding efficiency, providing performance comparable to more exhaustive search approaches without introducing meaningful degradation.

### BACKGROUND

Video compression is a technique for making video files smaller and easier to transmit over the Internet. There are different methods and algorithms for video compression, with different performance and tradeoffs. Video compression involves encoding and decoding. Encoding is the process of transforming (uncompressed) video data into a compressed format. Decoding is the process of restoring video data from the compressed format. An encoder-decoder system is called a codec.

A loop restoration filter is an in-loop filtering tool used in video coding to improve the quality of reconstructed frames by reducing artifacts introduced during compression. Applied after other in-loop filters (such as deblocking or directional enhancement filters), the loop restoration filter operates on reconstructed pixel values within the coding loop so that both encoder and decoder use the same filtered reference frames for subsequent prediction. By refining pixel values, the loop restoration filter enhances visual quality and coding efficiency while maintaining consistency between encoding and decoding processes.

### BRIEF DESCRIPTION OF THE DRAWINGS

Examples will be readily understood by the following detailed description in conjunction with the accompanying drawings. To facilitate this description, like reference numerals designate like structural elements. Examples are illustrated by way of example, and not by way of limitation, in the figures of the accompanying drawings.

FIG. 1 illustrates an encoding system and a plurality of decoding systems, according to some examples of the disclosure.

FIG. 2 illustrates an exemplary encoder to encode video frames and output an encoded bitstream, according to some examples of the disclosure.

FIG. 3 illustrates an exemplary decoder to decode an encoded bitstream and output a decoded video, according to some examples of the disclosure.

FIG. 4 illustrates an in-loop filter and a loop restoration filter decision part of an encoder, according to some examples of the disclosure.

FIG. 5 illustrates a loop restoration filter decision part, according to some examples of the disclosure.

FIG. 6 illustrates a full loop restoration filter parameter search process.

FIG. 7 illustrates a loop restoration filter parameter search process for a luma plane, according to some examples of the disclosure.

FIG. 8 illustrates a loop restoration filter parameter search process for a chroma plane that is adaptive to a quantization parameter and optionally a diversity metric, according to some examples of the disclosure.

FIG. 9 illustrates a loop restoration filter parameter search process having an adaptive frame filter mode decision, according to some examples of the disclosure.

FIG. 10 illustrates two block-variance histograms and thresholds, according to some examples of the disclosure.

FIG. 11 illustrates a process for determining a diversity metric and assessing whether a diversity condition is true, according to some examples of the disclosure.

FIG. 12 illustrates a loop restoration filter parameter search process having filter mode decision inheritance for non-anchor frames, according to some examples of the disclosure.

FIG. 13 illustrates a mini-group-of-pictures of size 8 (mini-GOP8) coding structure, according to some examples of the disclosure.

FIG. 14 illustrates a loop restoration filter parameter search process where a filter mode of a reference frame is inherited for non-anchor frames, according to some examples of the disclosure.

FIG. 15 illustrates a method for encoding a video, according to some examples of the disclosure.

FIG. 16 illustrates a method for encoding a video, according to some examples of the disclosure.

FIG. 17 illustrates a method for encoding a video, according to some examples of the disclosure.

FIG. 18 depicts a block diagram of an exemplary computing device, according to some examples of the disclosure.

### DETAILED DESCRIPTION

### Overview

Video coding or video compression is the process of compressing video data for storage, transmission, and playback. Video compression may involve taking a large amount of raw video data and applying one or more compression techniques to reduce the amount of data needed to represent the video while maintaining an acceptable level of visual quality. In some cases, video compression can offer efficient storage and transmission of video content over limited bandwidth networks.

A video includes one or more (temporal) sequences of video frames or frames. A frame may include an image, or a single still image. A frame may have millions of pixels. For example, a frame for an uncompressed 4K video may have a resolution of 3840×2160 pixels. Pixels may have luma/luminance and chroma/chrominance values. The terms “frame” and “picture” may be used interchangeably. There are several frame types or picture types. I-frames or intra-frames may be the least compressible and do not depend on other frames to decode. I-frames may include scene-change frames. P-frames may depend on data from previous frames to decode and may be more compressible than I-frames. B-frames may depend on data from previous and forward frames to decode and may be more compressible than I-frames and P-frames. Other frame types may include reference B-frames and non-reference B-frames. P-frames and B-frames may be referred to as inter-frames. The order in which I-frames, P-frames, and B-frames are arranged may be referred to as a group-of-pictures (GOP). A slice may be a spatially distinct region of a frame that is encoded separately from any other region in the same frame.

In some cases, a frame may be partitioned into one or more blocks. Blocks may be used for block-based compression. Blocks may have sizes that are much smaller, such as 512×512 pixels, 256×256 pixels, 128×128 pixels, 64×64 pixels, 32×32 pixels, 16×16 pixels, 8×8 pixels, 4×4 pixels, etc. A block may include a square or rectangular region of a frame. Various video compression techniques may use different terminology for the blocks or different partitioning structures for creating the blocks. In some video compression techniques, a frame may be partitioned into Coding Tree Units (CTUs). A CTU may be divided (separately for luma and chroma components) into Coding Tree Blocks (CTBs). A CTB can have a size of 64×64 pixels, 32×32 pixels, or 16×16 pixels. A CTB can be divided into Coding Units (CUs). A CU can be divided into Prediction Units (PUs) and/or discrete cosine transforms (DCT) Transform Units (TUs).

One of the tasks of an encoder in a video codec is to make encoding decisions at different levels for the video (e.g., sequence level, GOP level, frame/picture level, slice level, CTU level, CTB level, block level, CU level, PU level, TU level, etc.), based on a desired bitrate and/or desired (objective and/or subjective) quality. Making encoding decisions may include evaluating different options or parameter values for encoding the data, and determining optimal options or parameter values that may achieve the desired bitrate and/or quality. The chosen option and/or parameter values may be applied to encode the video to generate a bitstream. The chosen option and/or parameter values would be encoded in the bitstream to signal to a decoder how to decode the encoded bitstream in accordance with the encoding decisions that were made by the encoder. Modern codecs offer a wide range of options and parameter values. While evaluating all possible combinations of options and parameter values may yield the most optimal encoding decision, an encoder does not have unlimited resources to afford the complexity that would be required to make globally optimal encoding decisions.

The Alliance for Open Media (AOMedia) has launched a next evolution in open video coding: AOMedia Video 2 (AV2). AV2 is not only an upgrade to the widely adopted AOMedia Video 1 (AV1), but AV2 is also a foundational piece of AOMedia's future tech stack. As a generation leap in open video coding and the answer to the world's growing streaming demands, AV2 delivers significantly better compression efficiency than AV1. AV2 has achieved over 30% subjective quality improvement with similar bitrates and is designed to meet various future demands. In general, AV2 offers significant technical advantages over its predecessors, AV1, with the expense of ~30× average complexity increase in typical test conditions.

Despite the substantial coding efficiency gains achieved by AV2, the significantly increased encoder complexity presents a major challenge for practical deployment, particularly in real-time and hardware-constrained environments. One of the key contributors to this complexity is the loop restoration filter, an in-loop filtering tool applied to reconstructed frames to improve visual quality and coding efficiency. In the AOMedia Video Model (AVM), a reference AV2 codec software encoder implementation, loop restoration parameters, such as filter types, filter coefficients, and restoration-unit configurations, are determined through an exhaustive search procedure. These procedures evaluate numerous combinations of parameters using rate-distortion optimization, leading to substantial computational overhead. In particular, the final loop restoration parameters are selected based on a combination yielding the lowest rate-distortion cost. This exhaustive search involves deep, nested loops that blindly test every possibility, resulting in significant inefficiency and high computational cost.

To address this issue, one or more techniques can be implemented for the loop restoration parameter search to reduce the complexity of loop restoration parameter selection while maintaining or improving coding performance.

In some examples, a technique to reduce or limit loop restoration parameter search for luma planes involves configuring the encoder to operate in a frame filter mode (only). In this configuration, a frame filter mode flag is set to enable frame-level restoration filters for the luma plane and to disable restoration-unit-specific filters. For example, the frame filter mode flag can be set to 1 or true to enable frame-level restoration filters and disable restoration-unit-specific filters. The frame filter mode flag can be set to 0 or false to disable frame-level restoration filters and enable restoration-unit-specific filters. Frame filter mode and restoration-unit filter mode are mutually exclusive for a given plane. The encoder determines one or more frame-level restoration filters and selects among them based on associated rate-distortion costs. By focusing on frame-level filtering for the luma plane, the encoder reduces the need to derive and evaluate restoration-unit-specific filters, thereby significantly lowering computational complexity while leveraging the availability of multiple frame-level filter classes to maintain high coding efficiency.

In some examples, the determination of frame-level restoration filters for the luma plane includes evaluating candidate filters across multiple restoration-unit sizes and optionally referencing filters derived for one or more previously encoded reference frames. This reuse of filter information and structured evaluation can further reduce redundant or superfluous computations. Additionally, frame-level restoration filters may include non-separable Wiener filters or other advanced filtering techniques, enabling effective artifact reduction and quality enhancement despite the modified, limited, or reduced search process.

In some examples, a technique to reduce or limit loop restoration parameter search involves adaptively selecting loop restoration filter modes for chroma planes based on quantization parameters and optionally content characteristics. In particular, the encoder can determine whether a frame is to be processed using a restoration-unit filter mode based on a quantization parameter (QP) associated with the frame. For example, when the quantization parameter indicates lower compression levels (e.g., lower QP values), restoration-unit filtering may be evaluated or selected to preserve fine chroma details, whereas higher compression levels (e.g., higher QP values) may trigger additional analysis to determine an appropriate filtering mode.

In some examples, the technique can adapt to content characteristics, e.g., under certain quantization conditions (e.g., higher compression or higher QP values) by performing picture analysis on the chroma plane to evaluate color distribution characteristics. In one example, the encoder generates a variance histogram based on block-level variance measurements across the chroma plane. These block variances may be computed using computationally efficient operations, such as absolute differences of pixel values. The resulting histogram captures the distribution of color variation across the frame, enabling the encoder to assess whether the chroma content exhibits diverse or homogeneous characteristics.

Based on the histogram, the encoder can determine a diversity metric that reflects whether the chroma plane has a wide range of color variations or relatively uniform content. The diversity metric may be computed using counts of histogram bins corresponding to different block-percentage ranges, along with values associated with low-variance regions. When the chroma plane is determined to exhibit diverse color characteristics, restoration-unit filtering may be evaluated or selected to provide localized adaptation. Conversely, when the chroma plane is relatively uniform, frame-level filtering may be evaluated or selected to reduce signaling overhead and computational complexity while maintaining acceptable visual quality.

In some examples, a technique to reduce or limit loop restoration parameter search involves leveraging temporal consistency through anchor frames. The encoder determines whether a current frame is a non-anchor frame and, if so, configures loop restoration filter modes for the current frame based on a loop restoration filter mode previously determined for an encoded anchor frame. This approach enables reuse of filtering decisions across temporally related frames, thereby avoiding redundant parameter searches for each frame.

The determination of non-anchor frames may be based on one or more criteria, including one or more of: frame type, position within a hierarchical group-of-pictures structure, periodic selection strategies, and scene-change detection. For example, inter-frames or frames occupying non-leading positions within a mini-group-of-pictures may be classified as non-anchor frames. Frames between detected scene changes or frames outside periodically designated anchor positions may also be classified as non-anchor frames. These classification techniques allow flexible integration with different encoding configurations, including all-intra, low-delay, and random-access structures.

For anchor frames, the encoder may perform a more comprehensive loop restoration parameter search, evaluating both frame-level and restoration-unit-level filtering modes using rate-distortion optimization. The resulting filter mode selection for the anchor frame can then be reused by subsequent non-anchor frames. When applying this referenced configuration, the encoder sets one or more loop restoration mode flags accordingly and performs filter parameter search consistent with the inherited mode, thereby reducing computational effort while maintaining temporal consistency in visual quality.

The techniques described herein may be implemented independently or in various combinations to achieve different tradeoffs between encoding complexity and coding efficiency. In some implementations, the luma plane technique that utilizes frame-level restoration filtering may be applied independently to reduce complexity associated with restoration-unit-level processing, while chroma plane processing follows conventional approaches. In some implementations, the chroma adaptive frame filter mode decision based on quantization parameters and color analysis may be applied independently to enable per-frame adaptation of chroma filtering without modifying luma processing. In some implementations, the chroma frame filter mode reference technique may be applied independently, such that filter mode decisions for non-anchor frames are derived from anchor frames without performing per-frame analysis. In some implementations, combinations of these techniques may be employed, including combining the luma plane technique with the chroma adaptive decision, combining the luma plane technique with the anchor frame referencing technique, or combining the adaptive chroma decision with anchor frame referencing such that anchor frames are analyzed and non-anchor frames inherit the resulting decisions. In some implementations, all three techniques may be combined, where luma planes use frame-level filtering, chroma planes perform adaptive decision making for anchor frames, and non-anchor frames reuse previously determined filter modes. These combinations provide flexibility for encoder design, allowing selection of an appropriate balance between computational complexity and visual quality across a wide range of deployment scenarios.

In some examples, setting, for a chroma plane, a frame filter mode flag and a restoration-unit filter mode flag may be understood as an implementation variant of a single mode selection mechanism (e.g., AV2 has used a single mode flag, frame_filter_on flag). Because frame filter mode and restoration-unit filter mode can represent mutually exclusive operational configurations in the loop restoration parameter search, assigning one flag to indicate selection of frame-level filtering and another flag to indicate selection of restoration-unit-level filtering is functionally equivalent to setting a single mode flag that specifies one of the two modes. Accordingly, the use of two flags should be interpreted as one example of encoding a binary mode decision, and other equivalent representations, such as a single flag or enumerated mode indicator, may be used to convey the same selection.

The techniques described herein can be widely applicable across a variety of video coding systems and use cases. Although described in the context of AV2, the principles of adaptive filter mode selection, content-aware analysis, and temporal reuse of encoding decisions may be applied to other video coding standards and future codec designs. These approaches are particularly beneficial for hardware implementations, real-time encoding scenarios, and large-scale video processing systems, where reductions in computational complexity directly translate to improvements in power efficiency, throughput, and overall system performance.

Some experimental results demonstrate that the disclosed loop restoration techniques effectively preserve or improve coding efficiency while substantially reducing the need for exhaustive filter search. In particular, the results show that selecting filter modes through anchor-frame-based inheritance and chroma adaptive decisions provides performance comparable to more complex search approaches, while avoiding meaningful degradation even under higher quantization conditions.

Techniques for making loop restoration filtering decisions described and illustrated herein may be applied to a variety of codecs that may utilize loop restoration filtering as an in-loop filter. While the techniques described herein relate to AV2, it is envisioned by the disclosure that the techniques may be applied to other codecs having the loop restoration filter as an in-loop filter.

### Video Compression

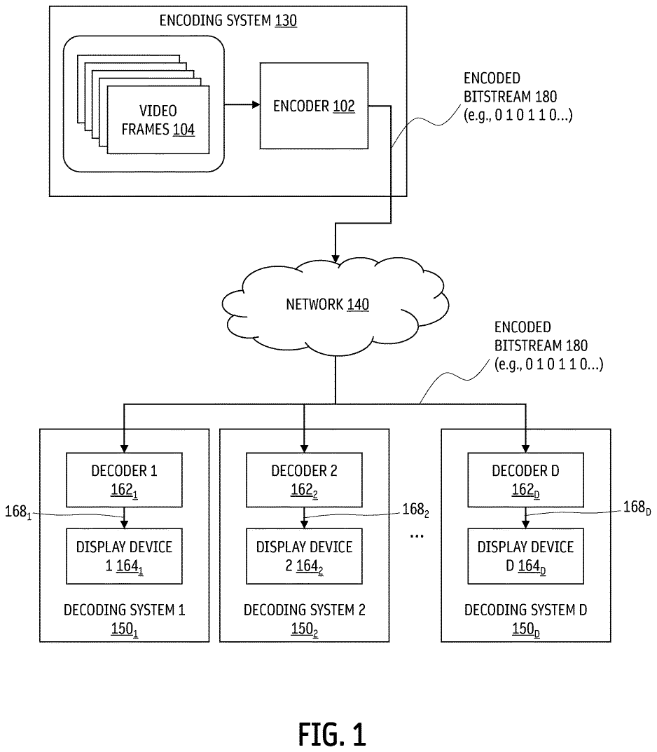

FIG. 1 illustrates encoding system 130 and one or more decoding systems 150_{1 . . . D}, according to some examples of the disclosure.

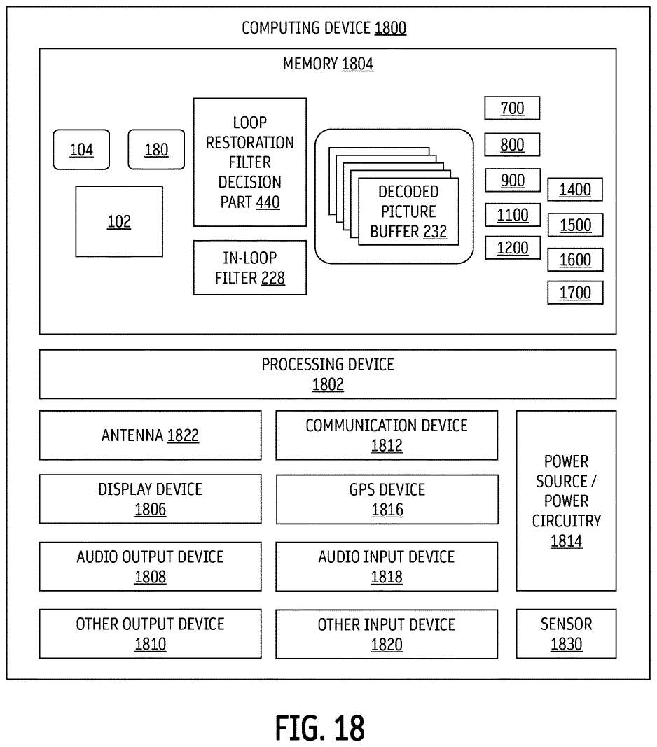

Encoding system 130 may be implemented on computing device 1800 of FIG. 18. Encoding system 130 can be implemented in the cloud or in a data center. Encoding system 130 can be implemented on a device that is used to capture the video. Encoding system 130 can be implemented on a standalone computing system. Encoding system 130 may perform the process of encoding in video compression. Encoding system 130 may receive a video (e.g., uncompressed video, original video, raw video, etc.) comprising a sequence of video frames 104. The video frames 104 may include image frames or images that make up the video. A video may have a frame rate or number of frames per second (FPS), that defines the number of frames per second of video. The higher the FPS, the more realistic and fluid the video looks. Typically, FPS is greater than 24 frames per second for a natural, realistic viewing experience to a human viewer. Examples of video may include a television episode, a movie, a short film, a short video (e.g., less than 15 seconds long), a video capturing gaming experience, computer screen content, video conferencing content, live event broadcast content, sports content, a surveillance video, a video shot using a mobile computing device (e.g., a smartphone), etc. In some cases, video may include a mix or combination of different types of video.

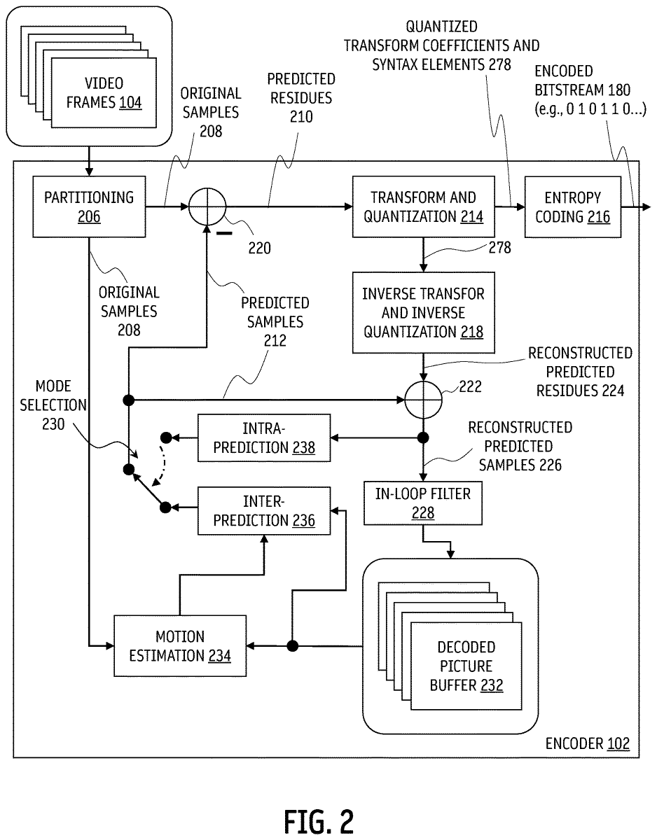

Encoding system 130 may include encoder 102 that receives video frames 104 and encodes video frames 104 into encoded bitstream 180. An exemplary implementation of encoder 102 is illustrated in FIG. 2.

Encoded bitstream 180 may be compressed, meaning that encoded bitstream 180 may be smaller in size than video frames 104. Encoded bitstream 180 may include a series of bits, e.g., having 0's and 1's. Encoded bitstream 180 may have header information, payload information, and footer information, which may be encoded as bits in the bitstream. Header information may provide information about one or more of: the format of encoded bitstream 180, the encoding process implemented in encoder 102, the parameters of encoder 102, and metadata of encoded bitstream 180. For example, header information may include one or more of: resolution information, frame rate, aspect ratio, color space, etc. Payload information may include data representing content of video frames 104, such as samples, frames, symbols, syntax elements, etc. For example, payload information may include bits that encode one or more of motion predictors, transform coefficients, prediction modes, and quantization levels of video frames 104. Footer information may indicate an end of the encoded bitstream 180. Footer information may include other information including one or more of: checksums, error correction codes, and signatures. The format of encoded bitstream 180 may vary depending on the specification of the encoding and decoding process, i.e., the codec.

Encoded bitstream 180 may include packets, where encoded video data and signaling information may be packetized. One exemplary format is the Open Bitstream Unit (OBU), which is used in AV1 encoded bitstreams. An OBU may include a header and a payload. The header can include information about the OBU, such as information that indicates the type of OBU. Examples of OBU types may include sequence header OBU, frame header OBU, metadata OBU, temporal delimiter OBU, and tile group OBU. Payloads in OBUs may carry quantized transform coefficients and syntax elements that may be used in the decoder to properly decode the encoded video data to regenerate video frames.

Encoded bitstream 180 may be transmitted to one or more decoding systems 150_{1 . . . D}, via network 140. Network 140 may be the Internet. Network 140 may include one or more of: cellular data networks, wireless data networks, wired data networks, cable Internet networks, fiber optic networks, satellite Internet networks, etc.

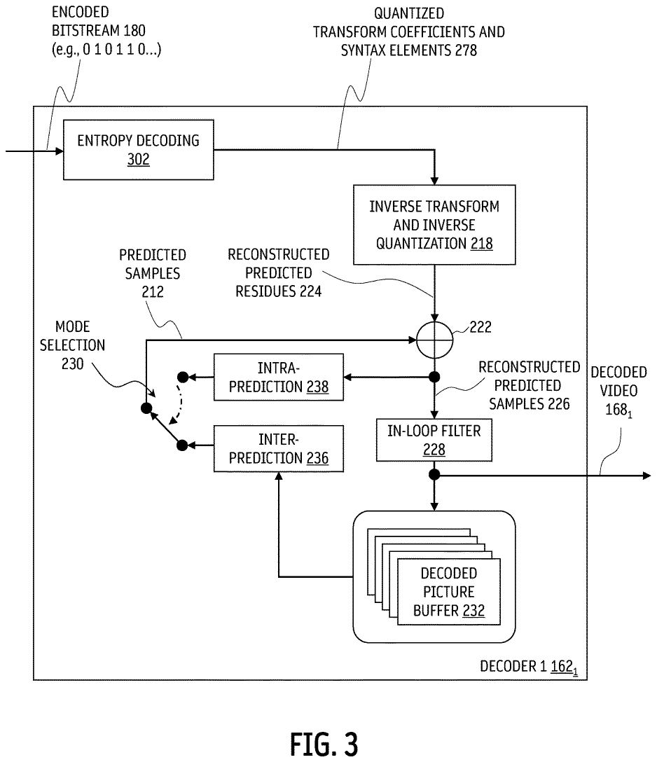

D number of decoding systems 150_{1 . . . D} are illustrated. At least one of the decoding systems 150_{1 . . . D} may be implemented on computing device 1800 of FIG. 18. Examples of systems 150_{1 . . . D} may include personal computers, mobile computing devices, gaming devices, augmented reality devices, mixed reality devices, virtual reality devices, televisions, etc. Each one of decoding systems 150_{1 . . . D} may perform the process of decoding in video compression. Each one of decoding systems 150_{1 . . . D} may include a decoder (e.g., decoder 1 . . . . D 162_{1 . . . D}), and one or more display devices (e.g., display device 1 . . . . D 164_{1 . . . D}). An exemplary implementation of a decoder, e.g., decoder 1 162₁, is illustrated in FIG. 3.

For example, decoding system 1 1501 may include decoder 1 1621 and a display device 1 164₁. Decoder 1 162₁ may implement a decoding process of video compression. Decoder 1 162₁ may receive encoded bitstream 180 and produce decoded video 168₁. Decoded video 168₁ may include a series of video frames, which may be a version or reconstructed version of video frames 104 encoded by encoding system 130. Display device 1 164₁ may output the decoded video 168₁ for display to one or more human viewers or users of decoding system 1 150₁.

For example, decoding system 2 1502 may include decoder 2 1622 and a display device 2 164₂. Decoder 2 162₂ may implement a decoding process of video compression. Decoder 2 162₂ may receive encoded bitstream 180 and produce decoded video 168₂. Decoded video 168₂ may include a series of video frames, which may be a version or reconstructed version of video frames 104 encoded by encoding system 130. Display device 2 164₂ may output the decoded video 168₂ for display to one or more human viewers or users of decoding system 2 150₂.

For example, decoding system D 150D may include decoder D 162D and a display device D 164_{D}. Decoder D 162_{D} may implement a decoding process of video compression. Decoder D 162_{D} may receive encoded bitstream 180 and produce decoded video 168_{D}. Decoded video 168_{D} may include a series of video frames, which may be a version or reconstructed version of video frames 104 encoded by encoding system 130. Display device D 164_{D} may output the decoded video 168_{D} for display to one or more human viewers or users of decoding system D 150_{D}.

### Video Encoder

FIG. 2 illustrates encoder 102 to encode video frames and output an encoded bitstream, according to some examples of the disclosure. Encoder 102 may include one or more of: signal processing operations and data processing operations, including inter- and intra-prediction, transform, quantization, in-loop filtering, and entropy coding. Encoder 102 may include a reconstruction loop involving inverse quantization, and inverse transformation to guarantee that the decoder would see the same reference blocks and frames. Encoder 102 may receive video frames 104 and encode video frames 104 into encoded bitstream 180. Encoder 102 may include one or more of partitioning 206, transform and quantization 214, inverse transform and inverse quantization 218, in-loop filter 228, motion estimation 234, inter-prediction 236, intra-prediction 238, and entropy coding 216.

Partitioning 206 may divide a frame in video frames 104 into blocks of pixels. Different codecs may allow different variable ranges of block sizes. In one codec, a frame may be partitioned by partitioning 206 into blocks of size 128×128 or 64×64 pixels. In some cases, a frame may be partitioned by partitioning 206 into blocks of size 32×32 pixels or 16×16 pixels. In some cases, a frame may be partitioned by partitioning 206 into blocks of 256×256 or 512×512 pixels. Large blocks may be referred to as superblocks. Partitioning 206 may further divide each superblock using a multi-way partition tree structure. In some cases, a partition of a superblock can be recursively divided further by partitioning 206 using the multi-way partition tree structure (e.g., down to 4×4 size blocks). In another codec, a frame may be partitioned by partitioning 206 into CTUs of size 128×128 pixels. Partitioning 206 may divide a CTU using a quadtree partitioning structure into four CUs. Partitioning 206 may further recursively divide a CU using the quadtree partitioning structure. Partitioning 206 may (further) subdivide a CU using a multi-type tree structure (e.g., a quadtree, a binary tree, or a ternary tree structure). A smallest CU may have a size of 4×4. Partitioning 206 may output original samples 208, e.g., as blocks of pixels.

Intra-prediction 238 may predict samples of a block from reconstructed predicted samples of previously encoded spatial neighboring/reference blocks of the same frame. Intra-prediction 238 may receive reconstructed predicted samples 226 (of previously encoded spatial neighbor blocks of the same frame). Reconstructed predicted samples 226 may be generated by summer 222 from reconstructed predicted residues 224 and predicted samples 212. Intra-prediction 238 may determine a suitable predictor for predicting the samples from reconstructed predicted samples of previously encoded spatial neighboring/reference blocks of the same frame. Intra-prediction 238 may generate predicted samples 212 using the suitable predictor. Intra-prediction 238 may output or identify the neighboring/reference block and a predictor used in generating the predicted samples 212. The identified neighboring/reference block and predictor may be encoded in the encoded bitstream 180 to enable a decoder to reconstruct a block using the same neighboring/reference block and predictor. In one codec, intra-prediction 238 may support a number of diverse predictors, e.g., 56 different predictors. Some predictors, e.g., directional predictors, may capture different spatial redundancies in directional textures. Pixel values of a block can be predicted using a directional predictor in intra-prediction 238 by extrapolating pixel values of a neighboring/reference block along a certain direction. Intra-prediction 238 of different codecs may support different sets of predictors to exploit different spatial patterns within the same frame. Examples of predictors may include direct current (DC), planar, Paeth, smooth, smooth vertical, smooth horizontal, recursive-based filtering modes, chroma-from-luma, intra-block copy, color palette, multiple-reference line, intra-sub-partition, matrix-based intra-prediction (matrix coefficients may be defined by offline training using neural networks), wide-angle prediction, cross-component linear model, template matching, etc. In some cases, intra-prediction 238 may perform block-prediction, where a predicted block may be produced from a reconstructed neighboring/reference block of the same frame using a vector. Optionally, an interpolation filter of a certain type may be applied to the predicted block to blend pixels of the predicted block. Pixel values of a block can be predicted using a vector compensation process in intra-prediction 238 by translating a neighboring/reference block (within the same frame) according to the vector (and optionally applying an interpolation filter to the neighboring/reference block) to produce predicted samples 212. Intra-prediction 238 may output or identify the vector applied in generating predicted samples 212. In some codecs, intra-prediction 238 may encode (1) a residual vector generated from the applied vector and a vector predictor candidate, and (2) information that identifies the vector predictor candidate, rather than encoding the applied vector itself. Intra-prediction 238 may output or identify an interpolation filter type applied in generating predicted samples 212.

Motion estimation 234 and inter-prediction 236 may predict samples of a block from samples of previously encoded frames, e.g., reference frames in decoded picture buffer 232. Motion estimation 234 and inter-prediction 236 may perform motion compensation, which may involve identifying a suitable reference block and a suitable motion predictor (or vector) for a block and optionally an interpolation filter to be applied to the reference block. Motion estimation 234 may receive original samples 208 from partitioning 206. Motion estimation 234 may receive samples from decoded picture buffer 232 (e.g., samples of previously encoded frames or reference frames). Motion estimation 234 may use a number of reference frames for determining one or more suitable motion predictors. A motion predictor may include a reference block and a motion vector that can be applied to generate a motion-compensated block or predicted block. Motion predictors may include motion vectors that capture the movement of blocks between frames in a video. Motion estimation 234 may output or identify one or more reference frames and one or more suitable motion predictors. Inter-prediction 236 may apply the one or more suitable motion predictors determined in motion estimation 234 and one or more reference frames to generate predicted samples 212. The identified reference frame(s) and motion predictor(s) may be encoded in the encoded bitstream 180 to enable a decoder to reconstruct a block using the same reference frame(s) and motion predictor(s). In one codec, motion estimation 234 may implement single reference frame prediction mode, where a single reference frame with a corresponding motion predictor is used for inter-prediction 236. Motion estimation 234 may implement compound reference frame prediction mode where two reference frames with two corresponding motion predictors are used for inter-prediction 236. In one codec, motion estimation 234 may implement techniques for searching and identifying good reference frame(s) that can yield the most efficient motion predictor. The techniques in motion estimation 234 may include searching for good reference frame(s) candidates spatially (within the same frame) and temporally (in previously encoded frames). The techniques in motion estimation 234 may include searching a deep spatial neighborhood to find a spatial candidate pool. The techniques in motion estimation 234 may include utilizing temporal motion field estimation mechanisms to generate a temporal candidate pool. The techniques in motion estimation 234 may use a motion field estimation process. After temporal and spatial candidates are ranked, a suitable motion predictor may be determined. In one codec, inter-prediction 236 may support a number of diverse motion predictors. Examples of predictors may include geometric motion vectors (complex, non-linear motion), warped motion compensation (affine transformations that capture non-translational object movements), overlapped block motion compensation, advanced compound prediction (compound wedge prediction, difference-modulated masked prediction, frame distance-based compound prediction, and compound inter-intra prediction), dynamic spatial and temporal motion vector referencing, affine motion compensation (capturing higher-order motion such as rotation, scaling, and shearing), adaptive motion vector resolution modes, geometric partitioning modes, bidirectional optical flow, prediction refinement with optical flow, bi-prediction with weights, extended merge prediction, etc. Optionally, an interpolation filter of a certain type may be applied to the predicted block to blend pixels of the predicted block. Pixel values of a block can be predicted using the motion predictor/vector determined in a motion compensation process in motion estimation 234 and inter-prediction 236 and optionally applying an interpolation filter. In some cases, inter-prediction 236 may perform motion compensation, where a predicted block may be produced from a reconstructed reference block of a reference frame using the motion predictor/vector. Inter-prediction 236 may output or identify the motion predictor/vector applied in generating predicted samples 212. In some codecs, inter-prediction 236 may encode (1) a residual vector generated from the applied vector and a vector predictor candidate, and (2) information that identifies the vector predictor candidate, rather than encoding the applied vector itself. Inter-prediction 236 may output or identify an interpolation filter type applied in generating predicted samples 212.

Mode selection 230 may be informed by components such as motion estimation 234 to determine whether inter-prediction 236 or intra-prediction 238 may be more efficient for encoding a block (thus making an encoding decision). Inter-prediction 236 may output predicted samples 212 of a predicted block. Inter-prediction 236 may output a selected predictor and a selected interpolation filter (if applicable) that may be used to generate the predicted block. Intra-prediction 238 may output predicted samples 212 of a predicted block. Intra-prediction 238 may output a selected predictor and a selected interpolation filter (if applicable) that may be used to generate the predicted block. Regardless of the mode, predicted residues 210 may be generated by subtractor 220 by subtracting original samples 208 from predicted samples 212. In some cases, predicted residues 210 may include residual vectors from inter-prediction 236 and/or intra-prediction 238.

Transform and quantization 214 may receive predicted residues 210. Predicted residues 210 may be generated by subtractor 220 that takes original samples 208 and subtracts predicted samples 212 to output predicted residues 210. Predicted residues 210 may be referred to as the prediction error of intra-prediction 238 and inter-prediction 236 (e.g., error between the original samples and predicted samples 212). Prediction error has a smaller range of values than the original samples and can be coded with fewer bits in encoded bitstream 180. Transform and quantization 214 may include one or more of transforming and quantizing. Transforming may include converting the predicted residues 210 from the spatial domain to the frequency domain. Transforming may include applying one or more transform kernels. Examples of transform kernels may include horizontal and vertical forms of DCT, asymmetrical discrete sine transform (ADST), flip ADST, and identity transform (IDTX), multiple transform selection, low-frequency non-separable transform, subblock transform, non-square transforms, DCT-VIII, discrete sine transform VII (DST-VII), discrete wavelet transform (DWT), etc. Transforming may convert the predicted residues 210 into transform coefficients. Quantizing may quantize the transformed coefficients, e.g., by reducing the precision of the transform coefficients. Quantizing may include using quantization matrices (e.g., linear and non-linear quantization matrices). The elements in the quantization matrix can be larger for higher frequency bands and smaller for lower frequency bands, which means that the higher frequency coefficients are more coarsely quantized, and the lower frequency coefficients are more finely quantized. Quantizing may include dividing each transform coefficient by a corresponding element in the quantization matrix and rounding to the nearest integer. Effectively, the quantization matrices may implement different QPs for different frequency bands and chroma planes and can use spatial prediction. A suitable quantization matrix can be selected and signaled for each frame and encoded in encoded bitstream 180. Transform and quantization 214 may output quantized transform coefficients and syntax elements 278 that indicate the coding modes and parameters used in the encoding process implemented in encoder 102.

Inverse transform and inverse quantization 218 may apply the inverse operations performed in transform and quantization 214 to produce reconstructed predicted residues 224 as part of a reconstruction path to produce decoded picture buffer 232 for encoder 102. Inverse transform and inverse quantization 218 may receive quantized transform coefficients and syntax elements 278. Inverse transform and inverse quantization 218 may perform one or more inverse quantization operations, e.g., applying an inverse quantization matrix, to obtain the unquantized/original transform coefficients. Inverse transform and inverse quantization 218 may perform one or more inverse transform operations, e.g., inverse transform (e.g., inverse DCT, inverse DWT, etc.), to obtain reconstructed predicted residues 224. A reconstruction path is provided in encoder 102 to generate reference blocks and frames, which are stored in decoded picture buffer 232. The reference blocks and frames may match the blocks and frames to be generated in the decoder. The reference blocks and frames are used as reference blocks and frames by motion estimation 234, inter-prediction 236, and intra-prediction 238.

In-loop filter 228 may implement filters to smooth out artifacts introduced by the encoding process in encoder 102 (e.g., processing performed by partitioning 206 and transform and quantization 214). In-loop filter 228 may receive reconstructed predicted samples 226 from summer 222 and output frames to decoded picture buffer 232. Examples of in-loop filters may include Cross-Component Sample Offset (CCSO) filter, guided detail filter (GDF), constrained low-pass filter, directional deringing filter, edge-directed conditional replacement filter, loop restoration filter, Wiener filter, self-guided restoration filters, constrained directional enhancement filter (CDEF), Luma Mapping with Chroma Scaling (LMCS), Sample Adaptive Offset (SAO) filter, Adaptive Loop Filter (ALF), cross-component ALF, low-pass filter, deblocking filter, etc. For example, applying a deblocking filter across a boundary between two blocks can resolve blocky artifacts caused by the Gibbs phenomenon. In some examples, in-loop filter 228 may fetch data from a frame buffer having reconstructed predicted samples 226 of various blocks of a video frame. Encoder 102 may determine whether to apply an in-loop filter or not. Encoder 102 may determine one or more suitable filters that achieve good visual quality and/or one or more suitable filters that suitably remove the artifacts introduced by the encoding process in encoder 102. After applying the one or more (suitable) filters, in-loop filter 228 may write (filtered) reconstructed samples to a frame buffer, such as decoded picture buffer 232.

Entropy coding 216 may receive quantized transform coefficients and syntax elements 278 (e.g., referred to herein as symbols) and perform entropy coding. Entropy coding 216 may generate and output encoded bitstream 180. Entropy coding 216 may exploit statistical redundancy and apply lossless algorithms to encode the symbols and produce a compressed bitstream, e.g., encoded bitstream 180. Entropy coding 216 may implement some version of arithmetic coding. Different versions may have different pros and cons. In one codec, entropy coding 216 may implement (symbol-to-symbol) adaptive multi-symbol arithmetic coding. In another codec, entropy coding 216 may implement context-based adaptive binary arithmetic coder (CABAC). Binary arithmetic coding differs from multi-symbol arithmetic coding. Binary arithmetic coding encodes only a bit at a time, e.g., having either a binary value of 0 or 1. Binary arithmetic coding may first convert each symbol into a binary representation (e.g., using a fixed number of bits per symbol). Handling just a binary value of 0 or 1 can simplify computation and reduce complexity. Binary arithmetic coding may assign a probability to each binary value (e.g., a chance of the bit having a binary value of 0 and a chance of the bit having a binary value of 1). Multi-symbol arithmetic coding performs encoding for an alphabet having at least two or three symbol values and assigns a probability to each symbol value in the alphabet. Multi-symbol arithmetic coding can encode more bits at a time, which may result in a fewer number of operations for encoding the same amount of data. Multi-symbol arithmetic coding can require more computation and storage (since probability estimates may be updated for every element in the alphabet). Maintaining and updating probabilities (e.g., cumulative probability estimates) for each possible symbol value in multi-symbol arithmetic coding can be more complex (e.g., complexity grows with alphabet size). Multi-symbol arithmetic coding is not to be confused with binary arithmetic coding, as the two different entropy coding processes are implemented differently and can result in different encoded bitstreams for the same set of quantized transform coefficients and syntax elements 278.

### Video Decoder

FIG. 3 illustrates decoder 1 162₁ to decode an encoded bitstream and output a decoded video, according to some examples of the disclosure. Decoder 1 162₁ may include one or more of: signal processing operations and data processing operations, including entropy decoding, inverse transform, inverse quantization, inter and intra-prediction, in-loop filtering, etc. Decoder 1 162₁ may have signal and data processing operations that mirror the operations performed in the encoder. Decoder 1 162₁ may apply signal and data processing operations that are signaled in encoded bitstream 180 to reconstruct the video. Decoder 1 162₁ may receive encoded bitstream 180 and generate and output decoded video 168₁ having a plurality of video frames. The decoded video 168₁ may be provided to one or more display devices for display to one or more human viewers. Decoder 1 162₁ may include one or more of entropy decoding 302, inverse transform and inverse quantization 218, in-loop filter 228, inter-prediction 236, and intra-prediction 238. Some of the functionalities are previously described and used in the encoder, such as encoder 102 of FIG. 2.

Entropy decoding 302 may decode the encoded bitstream 180 and output symbols that were coded in the encoded bitstream 180. The symbols may include quantized transform coefficients and syntax elements 278. Entropy decoding 302 may reconstruct the symbols from the encoded bitstream 180.

Inverse transform and inverse quantization 218 may receive quantized transform coefficients and syntax elements 278 and perform operations that are performed in the encoder. Inverse transform and inverse quantization 218 may output reconstructed predicted residues 224. Summer 222 may receive reconstructed predicted residues 224 and predicted samples 212 and generate reconstructed predicted samples 226. Inverse transform and inverse quantization 218 may output syntax elements 278 having signaling information for informing/instructing/controlling operations in decoder 1 162₁, such as mode selection 230, intra-prediction 238, inter-prediction 236, and in-loop filter 228.

Depending on the prediction modes signaled in the encoded bitstream 180 (e.g., as syntax elements in quantized transform coefficients and syntax elements 278), intra-prediction 238 or inter-prediction 236 may be applied to generate predicted samples 212.

Summer 222 may sum predicted samples 212 of a decoded reference block and reconstructed predicted residues 224 to produce reconstructed predicted samples 226 of a reconstructed block. For intra-prediction 238, the decoded reference block may be in the same frame as the block that is being decoded or reconstructed. For inter-prediction 236, the decoded reference block may be in a different (reference) frame in decoded picture buffer 232.

Intra-prediction 238 may determine a reconstructed vector based on a residual vector and a selected vector predictor candidate. Intra-prediction 238 may apply a reconstructed predictor or vector (e.g., in accordance with signaled predictor information) to the reconstructed block, which may be generated using a decoded reference block of the same frame. Intra-prediction 238 may apply a suitable interpolation filter type (e.g., in accordance with signaled interpolation filter information) to the reconstructed block to generate predicted samples 212.

Inter-prediction 236 may determine a reconstructed vector based on a residual vector and a selected vector predictor candidate. Inter-prediction 236 may apply a reconstructed predictor or vector (e.g., in accordance with signaled predictor information) to a reconstructed block, which may be generated using a decoded reference block of a different frame from decoded picture buffer 232. Inter-prediction 236 may apply a suitable interpolation filter type (e.g., in accordance with signaled interpolation filter information) to the reconstructed block to generate predicted samples 212.

In-loop filter 228 may receive reconstructed predicted samples 226. In-loop filter 228 may apply one or more filters signaled in the encoded bitstream 180 to the reconstructed predicted samples 226. In-loop filter 228 may output decoded video 168₁.

### In-Loop Filtering, Loop Restoration Filter Details, and Loop Restoration Filter Decision Making

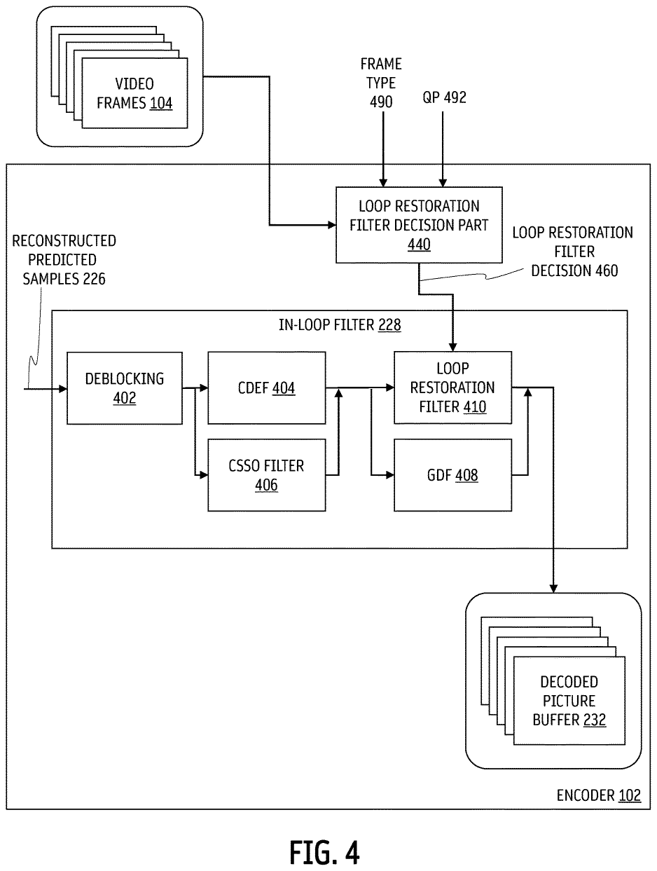

FIG. 4 illustrates in-loop filter 228 and loop restoration filter decision part 440 of encoder 102, according to some examples of the disclosure. In-loop filter 228 may be applied to reconstructed predicted samples 226, and post-filtering output may be output to decoded picture buffer 232. Decoded picture buffer 232 may be used as a reference for inter-prediction (e.g., inter-prediction 236 of FIG. 2) and/or intra-prediction (e.g., intra-prediction 238 of FIG. 2). In some video compression techniques, in-loop filter 228 may include a pipeline or series of in-loop filters, which may be individually or selectively disabled or enabled by syntax elements in the encoded bitstream.

In AV2, in-loop filter 228 can include one or more of: deblocking filter 402, CDEF 404, CCSO filter 406, loop restoration filter 410, and GDF 408. Deblocking filter 402 receives reconstructed predicted samples 226 as input and provides filtered output to both CCSO filter 406 and CDEF 404, which operate in parallel on the post-deblocking samples. CCSO filter 406 can derive correction offsets from reconstructed luma samples and apply them to luma and chroma components to reduce coding artifacts. CDEF 404 can perform constrained directional enhancement on the reconstructed samples independently of CCSO filter 406. The output of CCSO filter 406 (e.g., offsets) is applied to the output of CDEF 404 (e.g., corrected samples), and is subsequently provided as input to loop restoration filter 410 and optionally to GDF 408. If GDF 408 is applied, the output of GDF 408 can be added to the output of loop restoration filter 410. Loop restoration filter 410 and optionally GDF 408 can produce a final filtered output (e.g., corrected samples) for the pipeline of in-loop filter 228. In some examples, CCSO filter 406 and CDEF 404 may operate concurrently without mutual dependency, eliminating pipeline stalls and reducing hardware buffering requirements.

Loop restoration filter 410, inherited from AV1, has received some improvements in AV2 and contributed as one of the new tools giving the highest encoding quality gains. Optimal loop restoration parameter selection can have a significant impact on the encoding quality in the AV2 encoder. There are two main frame restoration types in loop restoration filter 410: pixel classification Wiener (PCW) filters and non-separable Wiener (NSW) filters. PCW filters use pre-trained, fixed filter coefficients that are known at both the encoder and decoder, enabling relatively low-complexity operation with minimal signaling overhead. In contrast, NSW filters use derived filter coefficients that are adapted to the characteristics of the video content, which can provide higher coding gains at the expense of increased computational complexity. In addition, a switchable restoration type may be supported, allowing different restoration types (e.g., PCW or NSW) to be selected for different restoration units within a frame.

In an AV2 encoding workflow, loop restoration filter 410 is applied as an in-loop filtering stage after other in-loop filters, such as deblocking filter 402 and CDEF 404. Loop restoration filter 410 operates on reconstructed pixel values, refining them to reduce compression artifacts and improve visual quality. Because the filtering occurs within the coding loop, the filtered frames are used as reference frames for subsequent prediction, making the accuracy and effectiveness of loop restoration filter 410 particularly beneficial for overall coding efficiency. Encoder 102 must therefore determine not only whether to apply loop restoration filter 410, but also the restoration type, filter parameters, and operating modes that would yield the best tradeoff between bitrate and distortion.

To achieve this, the encoder may partition each frame into restoration units (RUS), where each RU represents a region of the frame over which filtering decisions may be applied. For NSW filters, the encoder may operate in either a frame filter mode, in which a common set of filters is applied across all RUs in a frame, or a restoration-unit filter mode, in which each RU is allowed to use its own derived filter parameters. While the restoration-unit filter mode offers greater flexibility and can better adapt to local content variations, it incurs significant computational cost and signaling overhead. Conversely, the frame filter mode reduces complexity and overhead by sharing filters across the frame but may be less effective when content varies significantly across regions.

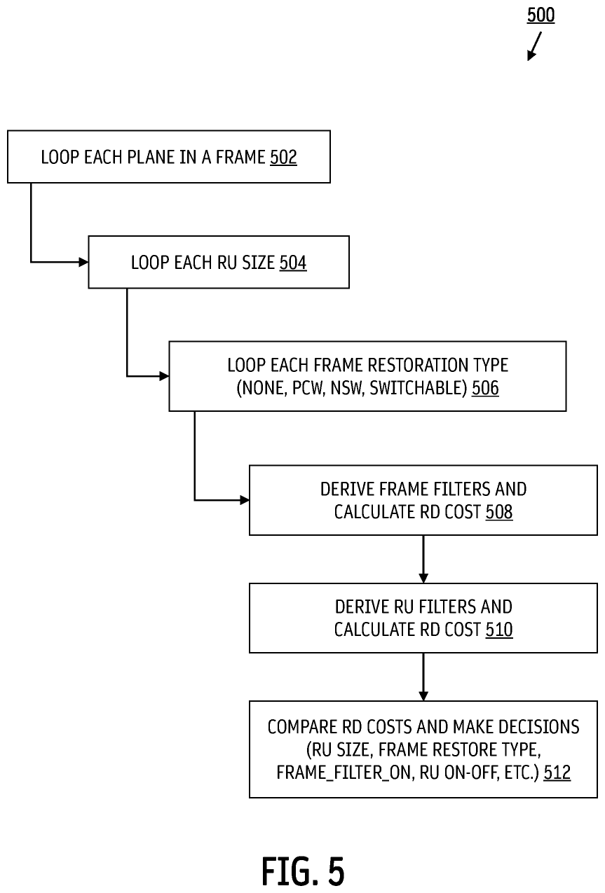

In some AV2 reference implementations, such as the AVM encoder, loop restoration parameters are selected through an exhaustive rate-distortion optimization process that evaluates multiple combinations of restoration types, RU sizes, filter coefficients, and mode configurations (as illustrated in FIG. 5). This process can involve iterating over different candidate configurations, deriving filters, applying them to reconstructed data, and computing rate-distortion costs to identify an optimal solution. Although this approach can achieve high coding efficiency, it is computationally intensive and may be impractical for real-time or hardware-constrained applications.

To better guide or limit the loop parameter search process or selection process, encoder 102 may include loop restoration filter decision part 440 to make one or more encoding decisions. In this case, loop restoration filter decision part 440 may make one or more loop restoration filter decisions 460. Loop restoration filter decision part 440 may output one or more loop restoration filter decisions 460 to control loop restoration filter 410. The one or more loop restoration filter decisions 460 may be encoded as syntax elements in the encoded bitstream.

Loop restoration filter decision part 440 may receive video frames 104. Loop restoration filter decision part 440 may receive one or more of frame type 490 and QP 492. Loop restoration filter decision part 440 may use one or more of: video frames 104, frame type 490, and QP 492 to determine one or more filter parameters (referred to herein as one or more loop restoration filter decisions 460) for loop restoration filter 410. Loop restoration filter decision part 440 may perform parameter search and rate-distortion optimization (RDO) when making one or more loop restoration filter decisions 460 for controlling loop restoration filter 410. RDO determines a tradeoff between the bitrate (e.g., a compression rate), and the distortion (e.g., quality, objective quality, subjective quality, etc.) introduced by the compression process. The goal of RDO is to make an optimal encoding decision (in this case, one or more loop restoration filter decisions 460) that minimizes a rate-distortion cost function that balances bitrate and distortion according to the following:

$$Cost = distortion + λ * bitrate \qquad ( 0 )$$

Cost represents the rate-distortion (RD) cost. distortion represents the distortion (e.g., mean squared error, sum of absolute differences, objective quality loss, subjective quality loss, etc.). bitrate represents the bitrate, or a number of bits to encode the data. λ or lambda is an RDO parameter (sometimes referred to as the Lagrangian multiplier) that can control or adjust the relative importance of bitrate versus distortion in the rate-distortion cost function. A higher value for A means more emphasis on reducing the bitrate. A lower value for λ means more emphasis on reducing distortion.

FIG. 5 illustrates a full loop restoration filter parameter search process.

In 502, an encoder loops through each plane in a frame. Performing the looping in 502 can include processing a luma plane and one or more chroma planes of a current frame so that loop restoration parameters can be determined on a plane-by-plane basis. In some examples, processing each plane separately allows the encoder to account for differences in filtering behavior and coding gain between luma and chroma data.

In 504, the encoder loops through each restoration-unit size for the plane being processed. Performing the looping in 504 can include evaluating a plurality of candidate RU sizes permitted by the codec syntax or configuration. In some examples, the candidate RU sizes may be constrained relative to superblock size and chroma format, such that the encoder evaluates multiple allowable RU-size options before selecting a restoration configuration for the plane. In some examples, there are three candidate RU sizes. In some examples, the candidate RU sizes can include one or more of: 64×64, 128×128, 256×256, and 512×512.

In 506, the encoder loops through each frame restoration type, including none, PCW, NSW, and switchable. Performing the looping in 506 can include evaluating whether no loop restoration is used, whether PCW filtering is used, whether NSW filtering is used, or whether a switchable mode is used in which different restoration types may be selected for different restoration units. In some examples, PCW filters use fixed, decoder-known filter coefficients and therefore can provide lower-complexity operation, while NSW filters use derived filter coefficients and can provide higher coding gains at the expense of greater computational complexity.

In 508, the encoder derives frame filters and calculates RD cost for the frame restoration type currently under evaluation. Performing the derivation in 508 can include deriving shared frame-level filters for the current plane and RU-size and then applying the derived frame filters to reconstructed pixel values to determine a corresponding RD cost. In some examples, for NSW filtering, deriving the frame filters can involve complex filter coefficient derivation operations, and the resulting frame-level RD cost reflects the coding efficiency obtained when restoration units in the plane share frame-level filters.

In 510, the encoder derives RU filters and calculates RD cost for the current frame restoration type. Performing the derivation in 510 can include deriving restoration-unit-specific filters for individual restoration units and determining an RD cost associated with those RU-level filters. In some examples, RU filtering provides greater local adaptation because different restoration units can use different filter parameters, but this increased flexibility is accompanied by greater derivation complexity and additional signaling overhead.

In 512, the encoder compares the RD costs and makes one or more loop restoration decisions. Performing the comparison in 512 can include selecting an RU-size, selecting a frame restoration type, determining whether a frame_filter_on flag is enabled, and determining one or more RU on-off decisions for the current plane.

The encoder signals the selected loop restoration configuration (e.g., decided in 512) in the bitstream using syntax elements associated with the frame and restoration units. For example, flags may indicate the chosen restoration type (e.g., none, PCW, NSW, or switchable), whether frame-level filtering is enabled, and, when applicable, parameters such as restoration-unit size and filter coefficients or class selections. These encoded syntax elements allow the decoder to reconstruct the same loop restoration behavior during decoding.

In some examples, the full search process 500 reflects an exhaustive AV2 loop restoration parameter search in which the encoder evaluates both frame-level filtering and RU-level filtering before selecting a restoration configuration that provides a desired tradeoff between bitrate, distortion, and encoder complexity. Among all the parameters of NSW filters, frame filter mode (e.g., frame_filter_on flag in uncompressed frame header) is a significant one because it determines whether restoration units use RU-specific filters (frame_filter_on=0) or the shared frame-level filters (frame_filter_on=1). In addition, the frame filter mode dominantly impacts the encoder's complexity and performance for loop restoration filtering. In the AVMedia reference encoder with exhaustive search, which blindly tests every possible combination of parameters, both frame filters (up to 16 set filters for a max of 16 classes) and RU filters (for each RU in a frame) are derived and go through the RD cost analysis to decide the best frame filter mode. As NSW filters are two-dimensional (2D) Wiener filters, the filter coefficient derivation involves complex 2D matrix operations, such as multiplication, transpose, and Cholesky decomposition. As seen in FIG. 5, the derivation of 16 frame filters and all RU filters are iteratively recomputed for each frame plane and every possible RU-size. Furthermore, the complex derivation process for even a single filter is iterated numerous times to search in the combinations of different filter shapes, all allowed values for each tap coefficient, and every RU on-off decision, etc. This immense computational effort severely degrades encoder performance.

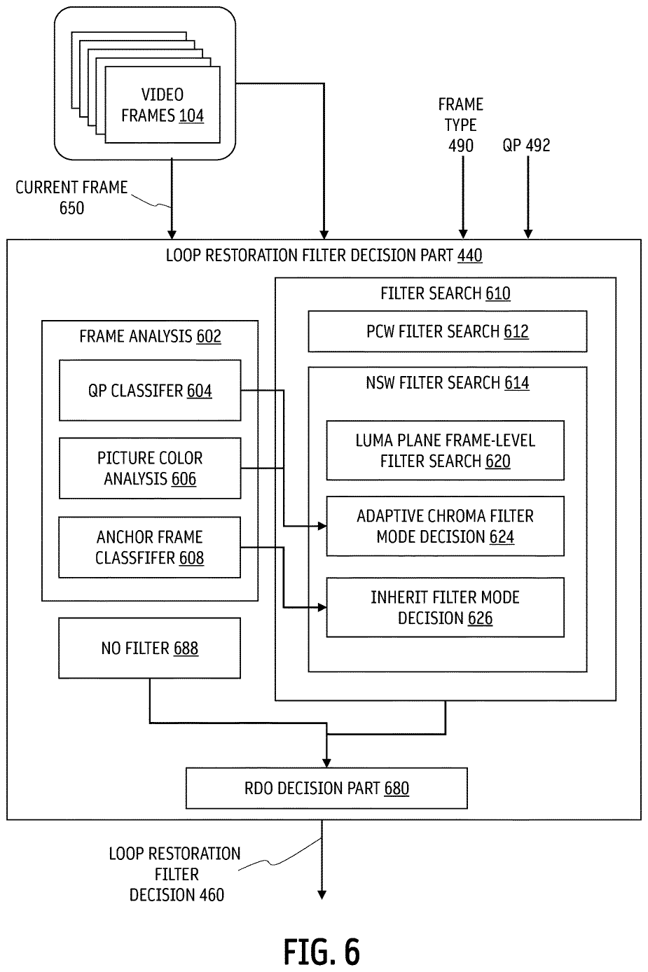

The technical challenge for loop restoration filter decision part 440 is to make one or more loop restoration filtering decisions 460 efficiently without sacrificing video quality. In particular, the technical task is to intelligently decide the frame filter mode and improve encoder performance while maintaining or enhancing encoding quality. Loop restoration filter decision part 440 can address this technical challenge by implementing operations and parts as described and illustrated in FIGS. 6-18.

FIG. 6 illustrates loop restoration filter decision part 440, according to some examples of the disclosure. Loop restoration filter decision part 440 receives current frame 650 from video frames 104, along with frame type 490 and QP 492 as optional inputs. Loop restoration filter decision part 440 produces one or more loop restoration filter decisions 460 as output, which governs whether and/or how loop restoration filtering is applied to current frame 650. Loop restoration filter decision part 440 comprises one or more of: frame analysis 602, filter search 610, no filter 688, and RDO decision part 680.

In some examples, one or more loop restoration filter decisions 460 can include any one or more of the decisions, mode settings, and parameter selections that determine whether loop restoration filtering is applied to current frame 650 and, if so, how loop restoration filtering is configured for one or more planes of current frame 650. For example, loop restoration filter decisions 460 can include one or more of: a decision to apply no loop restoration filtering, PCW filtering, NSW filtering, or switchable filtering, a decision selecting frame-level filtering or restoration-unit-level filtering for a plane, a setting of the frame_filter_on mode flag, one or more RU on-off decisions, a decision identifying whether a frame is processed as an anchor frame or a non-anchor frame for purposes of loop restoration mode selection, and, for non-anchor frames, a decision to inherit a loop restoration filter mode from an encoded anchor frame. Loop restoration filter decisions 460 can include one or more of: selection of a restoration-unit size, selection of one or more frame-level restoration filters, selection of one or more classes of frame-level restoration filters, selection of one or more restoration-unit-level filters or restoration-unit filter parameters, one or more RU on-off decisions, one or more decisions based on rate-distortion costs, one or more decisions based on QP classification, one or more decisions based on picture color analysis, one or more decisions based on whether a chroma plane meets a diversity condition, and one or more decisions based on frame analysis such as key-frame status, inter-frame status, mini-group-of-pictures position, periodic anchor frame selection, or scene-change-based classification. In some examples, loop restoration filter decisions 460 can also include derived or selected filter coefficients, references to frame-level filters selected for a reference frame, and any associated syntax-element values or mode indicator values used to signal the selected loop restoration configuration in a bitstream, such that loop restoration filter decisions 460 collectively govern both the structure of loop restoration processing and the specific parameters used to perform loop restoration filtering for current frame 650.

Frame analysis 602 can analyze characteristics of current frame 650 that can be relevant to loop restoration parameter selection. In some examples, filter search 610 can perform one or more restoration type searches responsive to outputs of frame analysis 602. No filter 688 can represent a decision path in which loop restoration filtering is not selected for current frame 650 or for a plane thereof. RDO decision part 680 can compare candidate results generated by, e.g., no filter 688 and filter search 610, to determine loop restoration filter decision 460. In some examples, loop restoration filter decision part 440 operates on a frame-by-frame basis and can make different decisions for different planes of current frame 650.

In some examples, frame analysis 602 comprises one or more of: QP classifier 604, picture color analysis 606, and anchor frame classifier 608.

QP classifier 604 can classify current frame 650 based on QP 492, such as by determining whether a quantization parameter associated with current frame 650 is below a threshold, above a threshold, or within a range.

Picture color analysis 606 can analyze color characteristics of a chroma plane of current frame 650, for example by generating a variance histogram based on block variances for blocks of the chroma plane and determining whether the chroma plane meets a diversity condition.

Anchor frame classifier 608 can determine whether current frame 650 is an anchor frame or a non-anchor frame. In some examples, anchor frame classifier 608 can classify current frame 650 as a non-anchor frame based on current frame 650 being an inter-frame, occupying a non-leading position in the encoding order of a hierarchical mini-group-of-pictures, being outside a periodic anchor frame selection, or being between detected scene-change frames.

In some examples, filter search 610 comprises one or more of: PCW filter search 612 and NSW filter search 614. PCW filter search 612 can evaluate pixel classification Wiener filtering for current frame 650. NSW filter search 614 can evaluate non-separable Wiener filtering for current frame 650 and comprises one or more of: luma plane frame-level filter search 620, adaptive chroma filter mode decision 624, and inherit filter mode decision 626.

Luma plane frame-level filter search 620 can implement a luma plane filter search process in which, for a luma plane of current frame 650, a frame filter mode flag is set to enable frame filter mode or allow the derivation of frame-level filters and disable restoration-unit filter mode or disallow the derivation of restoration-unit filters in a loop restoration parameter search, one or more frame-level restoration filters are determined for the luma plane, and a frame-level restoration filter is selected based on one or more rate-distortion costs associated with the one or more frame-level restoration filters. In some examples, luma plane frame-level filter search 620 enables loop restoration search for luma to be performed using frame-level restoration filters while reducing or removing complexity associated with restoration-unit-level searching.

Adaptive chroma filter mode decision 624 can implement a chroma plane embodiment in which frame analysis 602 controls whether a chroma plane is processed in a frame filter mode or in a restoration-unit filter mode. Adaptive chroma filter mode decision 624 can receive classification information from QP classifier 604 and optionally picture color analysis 606. In some examples, adaptive chroma filter mode decision 624 can determine whether current frame 650 is to be processed in a restoration-unit filter mode based on QP 492. In some examples, adaptive chroma filter mode decision 624 can determine whether current frame 650 is to be processed in a restoration-unit filter mode based on determining that a chroma plane meets a diversity condition (and optionally based on the QP being large). To process current frame 650 in a restoration-unit filter mode, the encoder can set a frame filter mode flag to disable frame filter mode or disable the derivation of frame-level filters and enable restoration-unit filter mode or allow the derivation of restoration-unit filters for the chroma plane. In some examples, based on determining that the chroma plane does not meet the diversity condition (and optionally based on the QP being large), adaptive chroma filter mode decision 624 can set the frame filter mode flag to enable frame filter mode or allow the derivation of frame-level filters and disable restoration-unit filter mode or disallow the derivation of restoration-unit filters for the chroma plane. Picture color analysis 606 can support this decision using block variances, variance histogram information, and a diversity metric derived therefrom.

Herein, setting the mode flag means configuring the encoder to operate in a specified loop restoration mode, such as a frame filter mode or a restoration-unit filter mode, thereby controlling how loop restoration filtering is performed. By setting the mode flag, the encoder limits the set of candidate filtering operations to be evaluated, such that parameter search associated with an alternative mode is omitted, which reduces computational complexity while guiding the selection of filtering parameters.

Inherit filter mode decision 626 can implement an anchor-frame-reference embodiment for chroma filtering. Inherit filter mode decision 626 can receive classification information from anchor frame classifier 608 and, based on current frame 650 being a non-anchor frame, can determine a loop restoration filter search mode configuration for current frame 650 by reference to a loop restoration filter mode previously determined for an encoded anchor frame. In some examples, inherit filter mode decision 626 can select a frame filter mode for current frame 650 when the encoded anchor frame uses frame filter mode, or can select a restoration-unit filter mode for current frame 650 when the encoded anchor frame uses restoration-unit filter mode.

In some examples, after the loop restoration filter search mode configuration is determined, inherit filter mode decision 626 can control a loop restoration filter search according to the determined search mode configuration. Performing the control can include, when the frame filter mode is selected, causing derive frame filters and calculate RD cost in 508 (illustrated in FIG. 5) to be performed and derive RU filters and calculate RD cost in 510 (illustrated in FIG. 5) to be omitted, and, when the restoration-unit filter mode is selected, causing derive RU filters and calculate RD cost in 510 to be performed and derive frame filters and calculate RD cost in 508 to be omitted.

In some examples, when current frame 650 is classified as an anchor frame, inherit filter mode decision 626 can enable a loop restoration filter search mode configuration that includes both frame filter mode and restoration-unit filter mode so that a fuller search can be performed for anchor frame coding.

In some examples, a loop restoration filter search mode configuration refers to a set of one or more control settings that define how a loop restoration filter search is conducted for a frame or a plane of the frame. The search mode configuration can specify which loop restoration filter modes are enabled for evaluation, such as enabling a frame filter mode, enabling a restoration-unit filter mode, or enabling both modes for comparative evaluation. In some examples, the search mode configuration controls which portions of the loop restoration parameter search are performed, such that operations associated with enabled modes are executed and operations associated with disabled modes are omitted. Accordingly, the loop restoration filter search mode configuration can define the scope and structure of the search process, including which candidate filtering approaches are considered and how loop restoration parameters are derived and evaluated.

RDO decision part 680 can receive candidate filtering outcomes from no filter 688, PCW filter search 612, and NSW filter search 614 and can determine loop restoration filter decision 460 based on rate-distortion optimization. RDO decision part 680 can compare coding costs associated with no filtering, PCW filtering, and NSW filtering, and can further compare coding costs associated with frame-level filtering and restoration-unit-level filtering for one or more planes. For simplicity, the switchable mode is omitted from the figure. However, it is contemplated that RDO decision part 680 may also receive candidate filtering outcomes corresponding to a switchable restoration mode in which different restoration types are applied across restoration units. In some examples, loop restoration filter decision 460 can specify whether loop restoration filtering is used, which restoration type is selected, and whether frame filter mode or restoration-unit filter mode is selected for one or more planes of current frame 650.

Loop restoration filter decision part 440 therefore supports multiple embodiments and multiple combinations of embodiments. In some examples, loop restoration filter decision part 440 can apply luma plane frame-level filter search 620 independently. In some examples, loop restoration filter decision part 440 can apply adaptive chroma filter mode decision 624 independently. In some examples, loop restoration filter decision part 440 can apply inherit filter mode decision 626 independently. In some examples, two or more of luma plane frame-level filter search 620, adaptive chroma filter mode decision 624, and inherit filter mode decision 626 can be used together, such as combining luma frame-level filtering with adaptive chroma filtering, or combining luma frame-level filtering with anchor-frame-based inheritance, or combining adaptive chroma filtering with anchor-frame-based inheritance. In some examples, all three of luma plane frame-level filter search 620, adaptive chroma filter mode decision 624, and inherit filter mode decision 626 are applied together, such that luma planes are processed using frame-level filtering, chroma planes of anchor frames are processed using adaptive filter mode decision, and chroma planes of non-anchor frames inherit loop restoration filter modes from corresponding anchor frames, thereby reducing loop restoration search complexity while maintaining coding efficiency.

### Skipping Restoration-Unit Filtering for Luma Plane

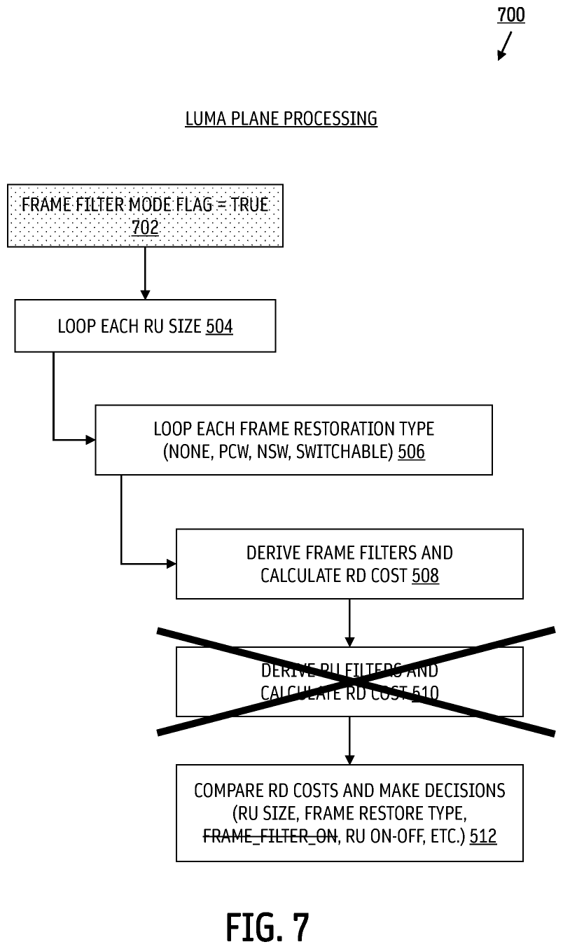

FIG. 7 illustrates a loop restoration filter parameter search process 700 for a luma plane, according to some examples of the disclosure. Process 700 can correspond to luma plane frame-level filter search 620 of FIG. 6 and can represent a luma-specific implementation of loop restoration parameter search in which frame-level filtering is selected for luma plane processing. In some examples, process 700 configures loop restoration search for the luma plane so that frame-level restoration filters are evaluated for the luma plane while restoration-unit-level filtering is not pursued or evaluated for the luma plane.

In 702, loop restoration filter decision part 440 sets a frame filter mode flag to true for the luma plane. Setting the frame filter mode flag to true enables frame filter mode and allows the derivation of frame-level filters in the loop restoration parameter search. Setting the frame filter mode flag to true disables restoration-unit filter mode and disallows the derivation of restoration-unit filters in the loop restoration parameter search. Performing the setting in 702 can include configuring an encoder to operate in a frame filter mode for the luma plane in a loop restoration parameter search (and omitting restoration-unit filter mode in the loop restoration parameter search). In some examples, setting the frame filter mode flag to true causes the luma plane search to proceed according to frame-level restoration filtering and reflects a determination that frame-level filtering is to be used for the luma plane.

In 504, loop restoration filter decision part 440 loops through each RU-size for the luma plane. Performing the looping in 504 can include evaluating a plurality of candidate RU sizes for the luma plane while the frame filter mode remains enabled. In some examples, process 700 retains RU-size evaluation for luma plane optimization while simplifying the search by maintaining frame-level filtering for the luma plane.

In 506, loop restoration filter decision part 440 loops through each frame restoration type for the luma plane. Performing the looping in 506 can include evaluating none, PCW, NSW, and switchable restoration types in connection with the luma plane search. In some examples, process 700 can evaluate one or more restoration types for the luma plane while continuing to use frame-level restoration filtering (for NSW) as configured by 702.

In 508, loop restoration filter decision part 440 derives frame filters and calculates rate-distortion cost for the luma plane. Performing the derivation in 508 can include determining one or more frame-level restoration filters for the luma plane and calculating one or more rate-distortion costs associated with the one or more frame-level restoration filters. In some examples, calculating the one or more rate-distortion costs includes applying the one or more frame-level restoration filters onto restoration units of the luma plane, and the one or more frame-level restoration filters can include one or more non-separable Wiener filters or one or more classes of filters specified for the luma plane.

In some examples, the frame filter search in 508 can be limited to one or more frame-level restoration filters used in a reference frame of the current frame. Performing the frame filter search in this manner can include determining one or more candidate frame-level restoration filters for the luma plane by reusing, selecting, or initializing from one or more frame-level filters previously selected for the reference frame. In some examples, limiting the search to frame-level restoration filters associated with the reference frame can reduce derivation complexity and narrow the candidate search space while still leveraging temporal correlation between the current frame and the reference frame.

510 is crossed out in FIG. 7 to indicate that RU-filter derivation and corresponding rate-distortion-cost calculation are omitted from process 700 for the luma plane. Performing process 700 can include omitting restoration-unit parameter search for the luma plane after frame filter mode has been selected and enabled in 702. In some examples, omission of 510 reflects that, for the luma plane, process 700 evaluates one or more frame-level restoration filters while reducing complexity associated with restoration-unit-level filter derivation and search.

In 512, loop restoration filter decision part 440 compares rate-distortion costs and makes one or more decisions for the luma plane. Performing the comparison in 512 can include selecting a restoration-unit size, selecting a frame restoration type, and selecting a frame-level restoration filter for the luma plane based on the one or more rate-distortion costs associated with the one or more frame-level restoration filters. In some examples, because RU-filter derivation is omitted in process 700, the decisions made in 512 for the luma plane are based on frame-level restoration filtering outcomes generated in 508.

In some examples, the luma plane frame-level filter search described with respect to process 700 is based on observed characteristics of luma filtering performance in AV2 loop restoration. In particular, frame-level filtering for the luma plane can achieve comparable or improved coding efficiency relative to restoration-unit-level filtering due to the availability of multiple filter classes that can be selected across restoration units. As a result, frame-level filtering can provide sufficient adaptability to spatial variations in luma content without requiring independent filter derivation at the restoration-unit level.

In some examples, the encoder may leverage a plurality of frame-level filter classes for the luma plane, where different restoration units select among the available classes while sharing a common set of derived frame-level filters. This approach enables localized adaptation while maintaining a simplified parameter search process. By contrast, restoration-unit-level filtering requires deriving and signaling filter parameters for each restoration-unit, which significantly increases computational complexity and bitstream overhead. Accordingly, restricting the luma plane search to frame-level filtering can reduce encoder complexity without materially degrading visual quality.

In some examples, the encoder may further exploit temporal redundancy by reusing or initializing luma frame-level filters based on filters associated with reference frames. This reuse can reduce the cost of filter derivation and improve convergence of the rate-distortion optimization process. Additionally, the encoder may evaluate candidate restoration-unit sizes in conjunction with frame-level filtering to identify an effective balance between spatial granularity and filtering performance.

In this manner, the luma plane frame-level filter search provides a structured and efficient alternative to exhaustive loop restoration parameter search for the luma plane. By eliminating restoration-unit-level filter derivation for luma while retaining one or more degrees of freedom, such as restoration type and restoration-unit size, the encoder can achieve a favorable tradeoff between computational complexity and coding efficiency, making the approach well-suited for both software encoders operating in fast modes and hardware implementations with constrained resources.

### Adaptive Frame Filter Mode Decision

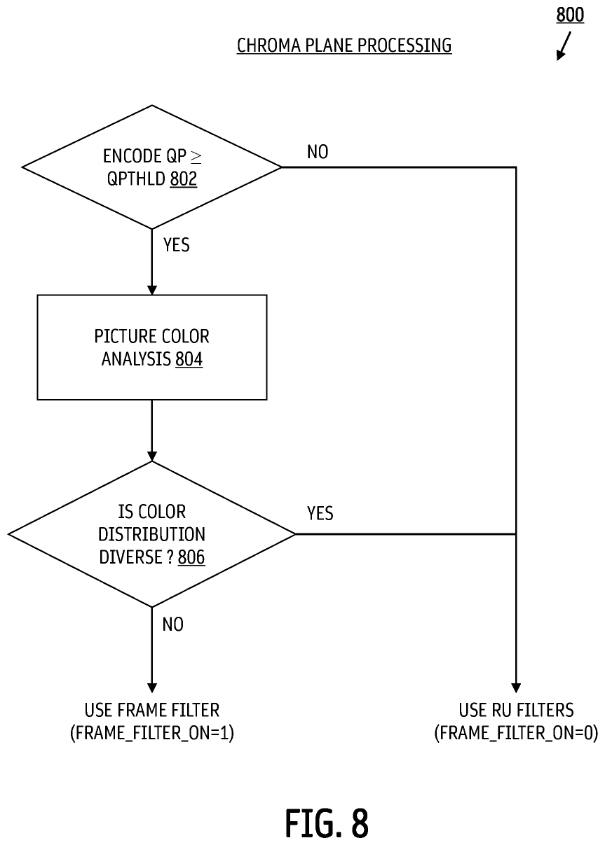

FIG. 8 illustrates loop restoration filter parameter search process 800 for a chroma plane that is adaptive to a quantization parameter and optionally a diversity metric, according to some examples of the disclosure. Process 800 can correspond to adaptive chroma filter mode decision 624 of FIG. 6 and can be used to control whether frame-level filtering or restoration-unit-level filtering is used for chroma plane processing. In some examples, process 800 sets a mode for the chroma plane before filter derivation and rate-distortion evaluation are performed, thereby reducing search complexity by omitting parameter search associated with an alternative mode.

In 802, loop restoration filter decision part 440 determines whether an encode quantization parameter of a current chroma plane is greater than or equal to a QP threshold, e.g., QPThld. Performing the determination in 802 can include comparing a quantization parameter associated with a frame against a threshold or determining whether the quantization parameter falls within a range. In some examples, 802 is performed using QP classifier 604 of FIG. 6, and the outcome of 802 controls whether process 800 proceeds to picture color analysis in 804 or directly selects restoration-unit filtering for the chroma plane.

When the determination in 802 is negative, process 800 proceeds to use RU filters with frame_filter_on set to 0. Setting the frame_filter_on mode flag to 0 disables frame filter mode (e.g., disallows the derivation of frame-level filters in the loop restoration parameter search) and enables restoration-unit filter mode (e.g., allows the derivation of restoration-unit filters in the loop restoration parameter search). Performing this branch can include setting, for the chroma plane, a frame filter mode flag to false to disable frame filter mode and enable restoration-unit filter mode in a loop restoration parameter search. In some examples, this branch in 802 reflects that, at lower quantization levels, chroma detail is better preserved and restoration-unit filtering can provide improved local adaptation for the chroma plane.

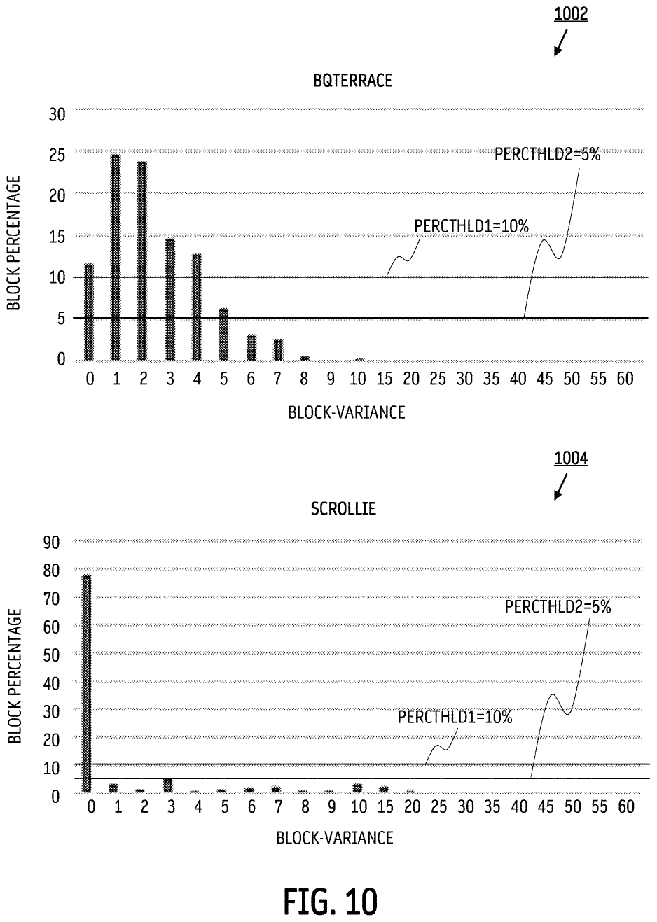

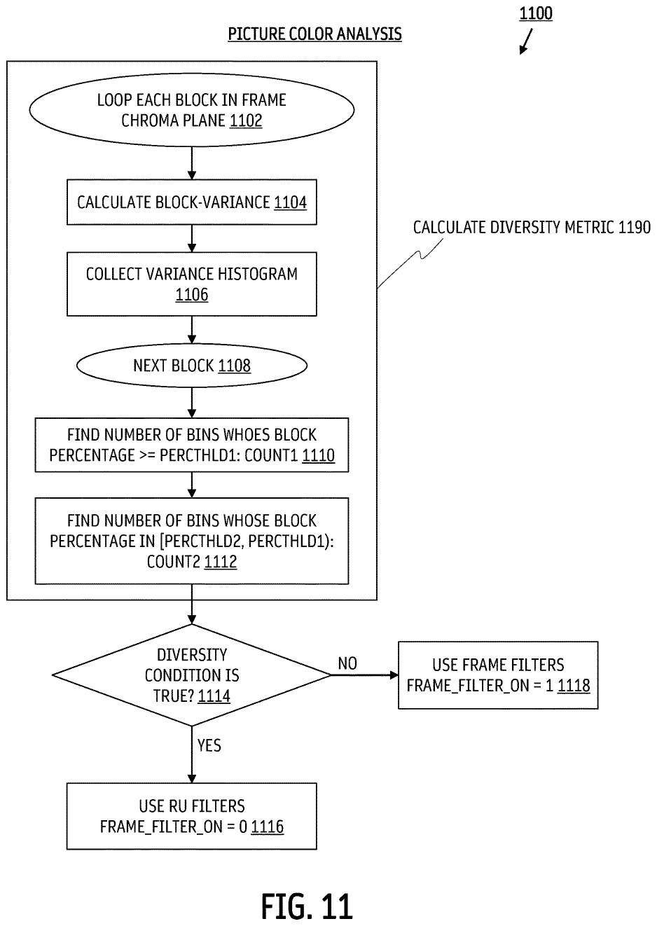

When the determination in 802 is affirmative, process 800 proceeds to 804. In 804, loop restoration filter decision part 440 performs picture color analysis for the chroma plane. Performing picture color analysis in 804 can include analyzing color characteristics of the chroma plane to determine whether a color distribution is clustered or spread out. In some examples, 804 is performed using picture color analysis 606 of FIG. 6 and can include generating a variance histogram based on block variances for blocks of the chroma plane, where the block variances are optionally calculated using absolute differences of pixel values in the blocks. Example implementations of 804 are further illustrated in FIGS. 10-11.

In 806, loop restoration filter decision part 440 determines whether the color distribution of the chroma plane is diverse. Performing the determination in 806 can include determining whether the chroma plane meets a diversity condition based on the output of 804. In some examples, determining whether the color distribution is diverse includes determining a diversity metric based on the variance histogram, such as by determining a count of histogram bins associated with a block-percentage range, determining a further count of histogram bins associated with a further block-percentage range, determining a value of a zero-variance histogram bin, and computing the diversity metric based on the count, the further count, and the value.

As used herein, a block-percentage range refers to a defined interval (e.g., between a lower percentage threshold and an upper percentage threshold) of block-percentage values in a distribution of blocks (such as a variance histogram), where a block-percentage for a given bin represents a percentage of blocks (of a frame or plane) whose associated measured value (e.g., block variance) falls within that bin, and where the block-percentage range is used to identify, count, or otherwise characterize bins whose block-percentage values fall within the interval for purposes of determining one or more metrics (e.g., a diversity metric) or making one or more encoding decisions.

When the determination in 806 is affirmative, process 800 proceeds to use RU filters with frame_filter_on set to 0. Setting the frame_filter_on mode flag to 0 disables frame filter mode (e.g., disallows the derivation of frame-level filters in the loop restoration parameter search) and enables restoration-unit filter mode (e.g., allows the derivation of restoration-unit filters in the loop restoration parameter search). Performing this branch can include setting, for the chroma plane, the frame filter mode flag to false to disable frame filter mode and enable restoration-unit filter mode. In some examples, selecting restoration-unit filtering in response to a diverse color distribution enables chroma filtering to better adapt to local variation across different restoration units of the chroma plane.

When the determination in 806 is negative, process 800 proceeds to use a frame filter with frame_filter_on set to 1. Setting the frame_filter_on mode flag to 1 enables frame filter mode (e.g., allows the derivation of frame-level filters in the loop restoration parameter search) and disables restoration-unit filter mode (e.g., disallows the derivation of restoration-unit filters in the loop restoration parameter search). Performing this branch can include setting, for the chroma plane, the frame filter mode flag to true to enable frame filter mode and disable restoration-unit filter mode. In some examples, selecting frame-level filtering in response to a less diverse color distribution reduces signaling overhead and search complexity while still providing effective chroma plane filtering.

Process 800 can be used to control subsequent operations of process 500 of FIG. 5 for the chroma plane. In some examples, when process 800 selects frame-level filtering, derive frame filters and calculate RD cost in 508 of FIG. 5 are performed for the chroma plane and derive RU filters and calculate RD cost in 510 of FIG. 5 are omitted for the chroma plane. In some examples, when process 800 selects restoration-unit filtering, derive RU filters and calculate RD cost in 510 of FIG. 5 are performed for the chroma plane and derive frame filters and calculate RD cost in 508 of FIG. 5 are omitted for the chroma plane. In this manner, compare RD costs and make decisions in 512 of FIG. 5 can operate on filtering outcomes associated with the mode selected by process 800 rather than requiring both chroma filter modes to be exhaustively searched.

In some examples, process 800 is based on differences between chroma plane filtering behavior and luma plane filtering behavior in AV2 loop restoration. Whereas luma frame filters can support multiple classes, AV2 currently supports only one class for a chroma frame filter. As a result, when a chroma frame filter is selected, an identical filter is applied across chroma restoration units in a frame, which can limit filtering efficiency when the frame contains regions with substantially different color characteristics. For example, a chroma plane may include richly textured or colorful regions in some areas and relatively flat or desaturated regions in other areas, such that a single chroma frame filter may not provide the same degree of adaptation that can be achieved with restoration-unit-level filtering.

In some examples, process 800 accounts for this chroma-specific limitation by selecting between frame-level filtering and restoration-unit-level filtering based on coding conditions associated with a current frame. At lower and mid-quantization levels, visual fidelity requirements may remain relatively high, and chroma detail may be better preserved in the reconstructed frame. Under these conditions, restoration-unit filtering can provide improved local adaptation because different restoration units can use different filter parameters responsive to local chroma content. Accordingly, process 800 can select restoration-unit filtering for the chroma plane when a quantization parameter associated with the frame indicates such lower or mid-quantization conditions.

In some examples, frame-level chroma filtering remains beneficial under higher quantization conditions. At higher quantization levels, greater compression may reduce or remove fine color detail, which can make a shared chroma frame filter more effective relative to its lower signaling cost and lower computational complexity. Thus, process 800 can use quantization parameter-based classification as an initial control for chroma plane loop restoration mode selection, such that restoration-unit filtering is selected for some quantization conditions and further decision making is invoked for other quantization conditions. This adaptive selection can simplify chroma plane loop restoration parameter search while maintaining or improving coding efficiency.

In some examples, after the quantization parameter-based classification indicates that further evaluation is appropriate, process 800 can proceed to picture color analysis for the chroma plane. The picture color analysis in 804 can be used to determine whether color statistics of the chroma plane are sufficiently diverse to favor restoration-unit filtering or sufficiently concentrated to favor frame-level filtering. In this manner, process 800 uses quantization parameter information as an initial gate and then uses picture analysis to further refine chroma plane filter mode selection. In some examples, 804 and 806 are omitted or optional.

In some examples, restoration-unit filtering for a chroma plane is selected without using a quantization parameter as a gating condition. For example, rather than first determining whether the QP satisfies a QP threshold in 802, loop restoration filter decision part 440 can perform picture color analysis (e.g., as in 804) for the chroma plane and determine whether the chroma plane meets a diversity condition (e.g., as in 806), and can then select restoration-unit filtering or frame-level filtering based on the outcome. In one example, when the diversity condition is true, the encoder sets frame_filter_on to 0 to enable restoration-unit filter mode and disallow derivation of frame-level filters, thereby providing localized adaptation for chroma regions having diverse color characteristics. In another example, when the diversity condition is false, the encoder sets frame_filter_on to 1 to enable frame filter mode and disallow derivation of restoration-unit filters, thereby reducing complexity and signaling overhead for chroma regions having less diverse color characteristics. In this manner, chroma loop restoration mode selection can be driven primarily by content-based picture analysis rather than QP-based classification while still providing an efficient mechanism to select between restoration-unit-level filtering and frame-level filtering.

In some examples, restoration-unit filtering for a chroma plane is selected based on a quantization parameter condition without performing picture color analysis. For example, loop restoration filter decision part 440 can compare the QP against a QP threshold in 802 and, based on the comparison, directly select between restoration-unit filter mode and frame filter mode for the chroma plane. In one example, when the QP condition indicates lower quantization (e.g., the QP is less than QPThld), the encoder sets frame_filter_on to 0 to enable restoration-unit filter mode and disallow derivation of frame-level filters, thereby providing localized chroma adaptation when more chroma detail is preserved. In another example, when the QP condition indicates higher quantization (e.g., the QP is greater than or equal to QPThld), the encoder sets frame_filter_on to 1 to enable frame filter mode and disallow derivation of restoration-unit filters, thereby reducing complexity and signaling overhead when chroma detail is more heavily quantized. In this manner, chroma loop restoration mode selection can be simplified to a QP-based classification while still providing a mechanism to control whether restoration-unit-level filtering is enabled for a given frame.

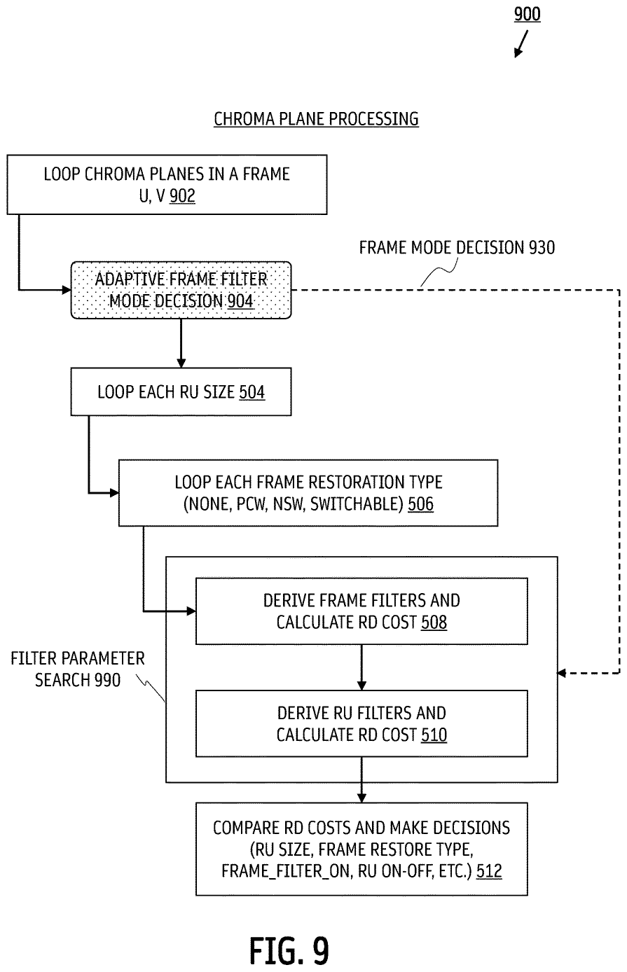

FIG. 9 illustrates loop restoration filter parameter search process 900 having an adaptive frame filter mode decision, according to some examples of the disclosure. Process 900 can be used for chroma plane processing and can incorporate frame mode decision 930 into filter parameter search 990. In some examples, process 900 corresponds to an implementation in which a frame filter mode or a restoration-unit filter mode is determined for a chroma plane before filter parameter search 990 is fully carried out, thereby reducing complexity associated with evaluating both chroma filter modes. In some examples, process 900 corresponds to adaptive chroma filter mode decision 624 of FIG. 6 and can represent a chroma plane-specific implementation of loop restoration filter decision part 440, in which frame mode decision 930 controls whether filter parameter search 990 proceeds according to frame-level filtering or restoration-unit-level filtering for a chroma plane.

In 902, loop restoration filter decision part 440 loops chroma planes in a frame, such as U and V planes. Performing the looping in 902 can include processing multiple chroma planes of a current frame on a plane-by-plane basis. In some examples, separate chroma plane processing allows loop restoration filtering decisions to account for chroma-specific filtering characteristics and content-dependent color variation.

In 904, loop restoration filter decision part 440 performs adaptive frame filter mode decision for a chroma plane (e.g., as illustrated in FIG. 8). Performing adaptive frame filter mode decision in 904 can include determining whether a frame is to be processed in a restoration-unit filter mode based on a quantization parameter associated with the frame and, in some examples, further determining whether the chroma plane meets a diversity condition based on picture color analysis. In some examples, 904 can generate frame mode decision 930, which indicates whether the chroma plane is to be processed using frame-level filtering or restoration-unit-level filtering. In some examples, 904 can be performed by adaptive chroma filter mode decision 624 in connection with QP classifier 604 and picture color analysis 606.

Frame mode decision 930 is provided to filter parameter search 990. Performing this control can include setting, for the chroma plane, a frame filter mode flag according to frame mode decision 930, so that one chroma filtering mode is selected for search. In some examples, setting the mode for the chroma plane causes parameter search associated with an alternative chroma filter mode to be omitted, thereby reducing loop restoration search complexity.

Filter parameter search 990 includes one or more of 508 and 510, which may be performed in a manner similar to that described with respect to FIG. 5, but under the control of frame mode decision 930. Process 900 can include looping through candidate restoration-unit sizes and frame restoration types. Filter parameter search 990 can perform filter derivation and rate-distortion evaluation according to the selected chroma filter mode. In some examples, when frame mode decision 930 selects frame-level filtering for the chroma plane, derive frame filters and calculate RD cost in 508 are performed and derive RU filters and calculate RD cost in 510 are omitted. In some examples, when frame mode decision 930 selects restoration-unit filtering for the chroma plane, derive RU filters and calculate RD cost in 510 are performed and derive frame filters and calculate RD cost in 508 are omitted.

In 512, loop restoration filter decision part 440 compares rate-distortion costs and makes one or more loop restoration decisions for the chroma plane. Performing the comparison in 512 can include selecting a restoration-unit size, selecting a frame restoration type, and confirming that the frame_filter_on mode flag setting is consistent with frame mode decision 930. In some examples, by making the adaptive frame filter mode decision before fully conducting filter parameter search 990, process 900 preserves effective chroma plane adaptation while reducing the computational burden of exhaustive evaluation of both frame-level and restoration-unit-level chroma filtering.

In some examples, frame mode decision 930 is made before filter parameter search 990 so that, once a chroma plane is classified for frame-level filtering or restoration-unit-level filtering, parameter search for the other chroma filtering mode is omitted, which is particularly beneficial because chroma frame filtering in AV2 currently supports only one class and therefore may be less suitable for frames having diverse color characteristics across different regions.

In some examples, determining whether the chroma plane meets a diversity condition based on picture color analysis (e.g., as illustrated by picture color analysis 606 in FIG. 6) in 904 can include using a histogram of block-variance in chroma planes as color statistics to detect if the color distribution is diverse or not, e.g., whether a diversity condition is met or not. Block-variance var can be calculated as in Equation (1). To reduce computation complexity, an absolute operation can be used instead of sum squared difference (SSD), though either can be used.

$$var = \frac{{\sum }_{( i , j ) ∈ blockN \times N} abs ( {p}_{( i , j )} - average )}{N * N} \qquad ( 1 )$$

$$average = \frac{{\sum }_{( i , j ) ∈ blockN \times N} {P}_{( i , j )}}{N * N} \qquad ( 2 )$$

abs( ) represents an absolute value operation. p_{(i,j)} is the U or V plane pixel value inside block N×N, and i, j=0, 1, . . . . N−1.

FIG. 10 illustrates two block-variance histograms and thresholds, according to some examples of the disclosure. Histogram 1002 is for a video frame in BQTerrace, a natural content where rich textures exist in several regions of chroma planes. Histogram 1004 is for ScrollIE, a screen content where texts are mainly clustered in the middle region of the frame and other regions are all very flat.

Histograms 1002 and 1004 can be generated as part of picture color analysis for a chroma plane, such as picture color analysis in 804 of FIG. 8 or picture color analysis 606 of FIG. 6. In some examples, a block-variance is determined for each of a plurality of blocks of a chroma plane, and the resulting block variances are accumulated into a histogram that indicates a distribution of block percentages across different block-variance values. The horizontal axis of each histogram corresponds to block-variance, and the vertical axis corresponds to block-percentage.

Histogram 1002 represents a frame having color and texture variation distributed across multiple regions of the chroma plane. In some examples, BQTerrace includes richer chroma textures and a broader range of local chroma characteristics, such that block variances are distributed across multiple variance values rather than being concentrated at a single value. This type of histogram can be associated with chroma content having more spatial diversity across the frame.

Histogram 1004 represents a frame in which chroma characteristics are more concentrated. In some examples, ScrollIE includes text concentrated in limited regions while other regions remain relatively flat, such that a large proportion of blocks have very low variance and comparatively fewer blocks contribute to other variance values. This type of histogram can be associated with chroma content in which variation is concentrated in fewer regions of the frame and large portions of the chroma plane exhibit relatively uniform characteristics.

FIG. 10 provides examples of how different types of chroma plane content can produce different block-variance distributions. In some examples, a more dispersed histogram shape can correspond to a frame having more varied chroma characteristics across blocks, while a more concentrated histogram shape can correspond to a frame having less varied or more regionally clustered chroma characteristics. These histogram characteristics can be used by picture color analysis to support subsequent filter mode decisions for chroma plane loop restoration.

FIG. 11 illustrates process 1100 for determining a diversity metric and assessing whether a diversity condition is true, according to some examples of the disclosure. Process 1100 can correspond to picture color analysis 606 of FIG. 6 and picture color analysis in 804 of FIG. 8 and can be used to determine whether a chroma plane meets a diversity condition for purposes of selecting frame-level filtering or restoration-unit filtering. In some examples, process 1100 includes calculating diversity metric 1190 for a chroma plane and then uses the resulting diversity metric and evaluation of the diversity metric against a diversity condition to control whether frame_filter_on is set to 1 or 0.

In 1102, loop restoration filter decision part 440 loops through each block in a chroma plane of a frame. Performing the looping in 1102 can include iterating through blocks of a U plane or a V plane of a current frame. In some examples, the blocks correspond to a block size used for picture color analysis, such as a block size corresponding to a superblock size, and the block size may be 64×64 in one example implementation.

In 1104, loop restoration filter decision part 440 calculates block-variance. Performing the calculation in 1104 can include determining a variance value for a current block based on pixel values in the chroma plane block. In some examples, calculating block-variance in 1104 uses absolute differences of pixel values in the block rather than a sum-of-squared-difference operation to reduce computation complexity while still capturing local chroma variation. In some examples, Equation (1) can be used to calculate the block-variance in 1104.

In 1106, loop restoration filter decision part 440 collects a variance histogram. Performing the collection in 1106 can include updating a variance histogram based on the block-variance calculated in 1104 so that block percentages are accumulated across different variance bins. In some examples, the variance histogram indicates how chroma plane blocks are distributed among different block-variance values and therefore captures whether color characteristics of the chroma plane are more concentrated or more spread out.

In 1108, loop restoration filter decision part 440 proceeds to the next block. Performing 1108 can include repeating 1104 and 1106 for additional blocks in the chroma plane until the variance histogram has been collected for the chroma plane. In some examples, 1102, 1104, 1106, and 1108 collectively produce histogram information in calculate diversity metric 1190.

In 1110, loop restoration filter decision part 440 finds the number of bins whose block-percentage is greater than or equal to a percentage threshold (e.g., PercThld1) and records count1. Performing 1110 can include determining a count of histogram bins of the variance histogram associated with a first block-percentage threshold. In some examples, count1 corresponds to the number of bins having a block-percentage greater than or equal to PercThld1 (a major significant percentage threshold).

In 1112, loop restoration filter decision part 440 finds the number of bins whose block-percentage is in a range between a further percentage threshold (e.g., PercThld2) and the percentage threshold (e.g., PercThld1) and records count2. Performing 1112 can include determining a further count of histogram bins of the variance histogram associated with a further block-percentage range. In some examples, count2 corresponds to the number of bins having a block-percentage less than PercThld1 and greater than or equal to PercThld2, thereby distinguishing bins associated with a lower but still significant block-percentage range from bins counted in 1110.

In some examples, count1 and count2 are derived from a variance histogram that represents a distribution of block variances across a chroma plane. Count1 corresponds to a number of histogram bins whose block-percentage is greater than or equal to a first threshold (e.g., PercThld1) and therefore identifies bins that represent dominant portions of the chroma plane. Count2 corresponds to a number of histogram bins whose block-percentage falls within a range between a second threshold and the first threshold (e.g., PercThld2 to PercThld1) and therefore identifies bins that represent moderately significant portions of the chroma plane. In this manner, count1 captures stronger contributors to the variance distribution, while count2 captures secondary contributors. Referring briefly to FIG. 10, the first and second thresholds (e.g., PercThld1=10% and PercThld2=5%) are shown on the histograms.

In some examples, count1 and count2 are used together to characterize how concentrated or dispersed the chroma plane content is across different variance levels. A smaller number of bins in count1 and count2 can indicate that a majority of blocks are concentrated in a limited number of variance bins, which corresponds to less diverse chroma characteristics. Conversely, a larger number of bins in count1 and count2 can indicate that block percentages are distributed across multiple variance bins, which corresponds to more diverse chroma characteristics. This characterization of distribution spread can be used in determining whether a chroma plane meets a diversity condition for purposes of selecting between frame-level filtering and restoration-unit-level filtering.

In 1114, loop restoration filter decision part 440 determines whether a diversity condition is true based on a diversity metric computed in calculate diversity metric 1190. Performing the determination in 1114 can include determining or computing a diversity metric based on count1 from 1110, count2 from 1112, and a value of a zero-variance histogram bin of the variance histogram.

In some examples, the value of the zero-variance histogram bin, VarHistgm[0], is compared against a yet further threshold (e.g., Thld3), such that the diversity condition reflects not only counts of significant histogram bins but also whether a substantial portion of the chroma plane blocks are concentrated in the zero-variance bin. In some examples, Thld3 is used as a threshold associated with a zero-variance histogram bin to further characterize concentration of chroma plane content. As described in the transcript, the value of the zero-variance bin, VarHistgm[0], represents a percentage of blocks having little to no variation in chroma values. Thld3 is therefore used to determine whether a substantial portion of the chroma plane is flat or uniform. When VarHistgm[0] satisfies Thld3, this indicates that a large percentage of blocks fall into the zero-variance category, suggesting that the chroma content is highly concentrated and less diverse. Conversely, when VarHistgm[0] does not satisfy Thld3, this indicates that fewer blocks are concentrated in the zero-variance bin, suggesting greater variation across the chroma plane. In this manner, Thld3 provides an additional measure, beyond count1 and count2, for evaluating whether the chroma plane content exhibits sufficient diversity to favor restoration-unit filtering. In some examples, evaluation against Thld3 is omitted or skipped.

In some examples, the diversity metric can be represented as:

$$diversity\_metric = ! ( count1 \leq CntThld 1 and count 2 \leq CntThld 2 and Var Histgm [ 0 ] > Thld 3 \qquad ( 3 )$$

In some examples, CntThld1 is 4, and CntThld2 is 4.

In some examples, a diversity metric refers to a quantitative measure that characterizes a distribution of block variances across a chroma plane. The diversity metric can be derived from a variance histogram that represents block percentages associated with different variance bins. In some examples, the diversity metric is determined based on one or more counts of histogram bins satisfying respective block-percentage thresholds, such as a first count (count1) corresponding to bins exceeding a first threshold and a second count (count2) corresponding to bins within a second range, and optionally further based on a value associated with a zero-variance bin. The diversity metric therefore captures both the spread of variance values across bins and the concentration of blocks in low-variance regions and provides an indication of whether chroma plane content is distributed across multiple variance levels or concentrated in a limited set of variance levels.

In some examples, the determination of the diversity metric in 1114 results in either a positive outcome indicating that the diversity condition is true or a negative outcome indicating that the diversity condition is false. Performing the determination in 1114 can include comparing diversity metric 1190 against one or more criteria derived from count1, count2, and (optionally) the zero-variance histogram value. A positive result reflects that the chroma plane content is sufficiently diverse across blocks, while a negative result reflects that the chroma plane content is more concentrated. The outcome of 1114 directly controls subsequent selection of loop restoration filtering, such that a positive result leads to selection of restoration-unit filtering in 1116 and a negative result leads to selection of frame-level filtering in 1118.

In some examples, a diversity condition refers to a decision criterion based on the diversity metric that indicates whether a chroma plane exhibits sufficiently diverse characteristics to favor restoration-unit-level filtering. The diversity condition can be evaluated by comparing the diversity metric against one or more criteria derived from the counts of histogram bins and the zero-variance bin value. In some examples, the diversity condition is satisfied when the variance histogram indicates that block percentages are distributed across multiple bins and are not predominantly concentrated in the zero-variance bin. Conversely, the diversity condition is not satisfied when the histogram indicates that a substantial portion of blocks are concentrated in a limited number of bins, particularly the zero-variance bin. The result of evaluating the diversity condition can be used to select between frame-level filtering and restoration-unit-level filtering for the chroma plane.

In 1116, loop restoration filter decision part 440 uses RU filters with frame_filter_on equal to 0 to disable frame filter mode (e.g., disallow the derivation of frame-level filters in a loop restoration parameter search) and enable restoration-unit filter mode (e.g., allow the derivation of restoration-unit filters in the loop restoration parameter search) in response to the diversity condition being true. Performing 1116 can include setting, for the chroma plane, a frame filter mode flag to false to disable frame filter mode and enable restoration-unit filter mode. In some examples, selecting restoration-unit filtering in 1116 enables more localized chroma plane adaptation when the variance histogram indicates that color characteristics are sufficiently diverse across different blocks.

In 1118, loop restoration filter decision part 440 uses frame filters with frame_filter_on equal to 1 to enable frame filter mode (e.g., allow the derivation of frame-level filters in a loop restoration parameter search) and disable restoration-unit filter mode (e.g., disallow the derivation of restoration-unit filters in the loop restoration parameter search) in response to the diversity condition being false. Performing 1118 can include setting, for the chroma plane, a frame filter mode flag to true to enable frame filter mode and disable restoration-unit filter mode.

In some examples, process 1100 provides a hardware-efficient mechanism for distinguishing between chroma planes that are better suited to shared frame-level filtering and chroma planes that are better suited to restoration-unit-level filtering, thereby supporting adaptive chroma filter mode decision 624 and reducing loop restoration search complexity.

Inheriting Filter Mode Decision from a Reference Frame for Non-Anchor Frames

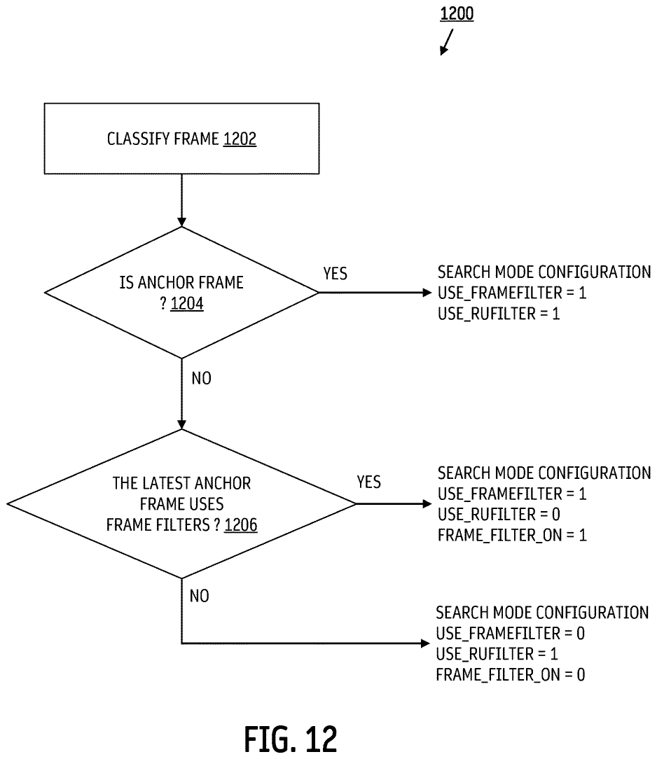

FIG. 12 illustrates loop restoration filter parameter search process 1200 having filter mode decision inheritance for non-anchor frames, according to some examples of the disclosure. Process 1200 can be applied to set a loop restoration filter search mode configuration based on anchor frame classification. Process 1200 can correspond to inherit filter mode decision 626 of FIG. 6 and can be used to support chroma frame filter mode reference from anchor frames. In some examples, process 1200 determines whether a frame is an anchor frame or a non-anchor frame and then sets a search mode configuration for a loop restoration filter search based on that classification.

In 1202, loop restoration filter decision part 440 classifies a frame. Performing the classification in 1202 can include analyzing a current frame to determine whether the frame is to be treated as an anchor frame or a non-anchor frame for purposes of loop restoration filter search. In some examples, classifying a frame in 1202 can be performed using one or more of: frame type, position in encoding order, periodic anchor frame selection, and scene-change information.

In 1204, loop restoration filter decision part 440 determines whether a frame is an anchor frame. Performing the determination in 1204 can include deciding whether the current frame satisfies one or more anchor frame criteria. In some examples, when the determination in 1204 is affirmative, process 1200 sets the search mode configuration to include USE_FRAMEFILTER=1 and USE_RUFILTER=1, which indicates that frame filter mode and restoration-unit filter mode are both evaluated and/or considered for the loop restoration filter search for the frame. In some examples, enabling both modes for an anchor frame allows a fuller search to be performed so that a loop restoration filter mode can be decided for the anchor frame based on search results.

When the determination in 1204 is negative, process 1200 proceeds to 1206. In 1206, loop restoration filter decision part 440 determines whether the latest anchor frame uses frame-level filters. Performing the determination in 1206 can include referencing a further loop restoration filter mode decided for an encoded anchor frame and determining whether the encoded anchor frame used frame filter mode or restoration-unit filter mode. In some examples, 1206 can enable inheritance of loop restoration filter mode from the latest encoded anchor frame for a non-anchor frame.

When the determination in 1206 is affirmative, process 1200 sets the search mode configuration to USE_FRAMEFILTER=1 and USE_RUFILTER=0. The filtering mode flags may be set as frame_filter_on=1 to enable frame filter mode (e.g., allow frame-level filters to be evaluated and/or considered in the loop restoration filter search) and disable restoration-unit filter mode (e.g., disallow restoration-unit filters to be evaluated and/or considered in the loop restoration filter search). Setting the search mode configuration can involve selecting frame filter mode for the frame based on the encoded anchor frame using frame filter mode. In some examples, setting frame_filter_on=1 causes the loop restoration filter search for the frame to proceed according to frame-level filtering.

When the determination in 1206 is negative, process 1200 sets the search mode configuration to USE_FRAMEFILTER=0 and USE_RUFILTER=1. The mode flags may be set as frame_filter_on=0 to disable frame filter mode (e.g., disallow frame-level filters to be evaluated and/or considered in the loop restoration filter search) and enable restoration-unit filter mode (e.g., allow restoration-unit filters to be evaluated and/or considered in the loop restoration filter search). Setting the search mode configuration can involve selecting restoration-unit filter mode for the frame based on the encoded anchor frame using restoration-unit filter mode. In some examples, setting frame_filter_on=0 causes the loop restoration filter search for the frame to proceed according to restoration-unit-level filtering.

Process 1200 can provide a mechanism by which loop restoration filter search for non-anchor frames is controlled based on a loop restoration filter mode previously decided for an encoded anchor frame. In some examples, this anchor-frame-referenced search mode configuration reduces complexity by avoiding a fuller search for both frame filter mode and restoration-unit filter mode on non-anchor frames, while still allowing anchor frames to be searched with both modes enabled.

In some examples, process 1200 is based on an observation that restoration-unit filtering is substantially more complex than frame-level filtering because restoration-unit filtering involves deriving filters for individual restoration units, whereas frame-level filtering derives filters once for a frame or plane. Accordingly, process 1200 can use anchor-frame-based mode reference to reduce repeated restoration-unit-level search on non-anchor frames while still permitting higher-complexity search on anchor frames. This approach can be particularly useful in hardware-oriented implementations, where repeated restoration-unit-level derivation across many frames can be difficult to support efficiently.

In some examples, anchor frames are selected because they serve as significant reference points for subsequent frames, and therefore it can be beneficial to perform a fuller loop restoration search on those frames. For example, when a frame is classified as an anchor frame, process 1200 can evaluate and/or consider both frame filter mode and restoration-unit filter mode so that a rate-distortion-based decision can be made between the two. By contrast, for a non-anchor frame, process 1200 can avoid repeating the fuller dual-mode search and instead can rely on the loop restoration filter mode previously decided for the latest encoded anchor frame.

In some examples, the mode used by the latest encoded anchor frame provides an indicator of whether frame-level filtering is likely sufficient for related non-anchor frames or whether restoration-unit-level filtering is likely to remain beneficial. When the latest encoded anchor frame uses frame filter mode, process 1200 can set the search mode configuration for the non-anchor frame so that frame-level filtering is used. When the latest encoded anchor frame uses restoration-unit filter mode, process 1200 can set the search mode configuration for the non-anchor frame so that restoration-unit-level filtering is used. In this manner, process 1200 leverages temporal correlation between frames to reduce search complexity while maintaining effective loop restoration decisions.

In some examples, process 1200 can be used independently or in combination with other loop restoration decision techniques. For example, anchor-frame-based mode reference can be used alone for chroma plane loop restoration search, or can be combined with quantization parameter-based and picture-analysis-based chroma decision making such that anchor frames are analyzed more fully and non-anchor frames inherit a selected mode. In further examples, process 1200 can be used together with luma plane frame-level filter search so that luma planes and chroma planes are controlled using different complexity-reduction strategies within a common loop restoration decision framework.

In some examples, a frame may be identified as an anchor frame or a non-anchor frame in 1202 based on a frame type-based criterion. For example, intra-frames or key frames may be treated as anchor frames because they do not depend on other frames and often serve as reference points for subsequent frames, while inter-frames, such as P-frames or B-frames, may be classified as non-anchor frames. Performing classification in this manner can include determining whether a frame is an inter-frame. Based on the determination, the frame can be classified as a non-anchor frame. This approach leverages existing frame type signaling in the bitstream and provides a low-complexity mechanism for identifying anchor and non-anchor frames.

In some examples, a frame may be identified as an anchor frame or a non-anchor frame in 1202 based on a periodic selection process. For example, in an all-intra or other encoding configuration, one or more frames may be periodically selected as anchor frames according to a predefined interval, and remaining frames may be classified as non-anchor frames. Performing classification in this manner can include identifying anchor frames at regular intervals and assigning non-anchor status to frames that do not meet the periodic selection criterion. This approach enables consistent distribution of anchor frames across a sequence and can be used when a hierarchical prediction structure is not available or not relied upon.

In some examples, a frame may be identified as an anchor frame or a non-anchor frame in 1202 based on scene-change detection. For example, frames associated with scene changes may be classified as anchor frames, and frames occurring between scene-change frames may be classified as non-anchor frames. Performing classification in this manner can include detecting one or more scene-change frames and classifying frames between the detected scene-change frames as non-anchor frames. This approach leverages content-based segmentation of a video sequence and can ensure that anchor frames correspond to significant changes in visual content, thereby improving the effectiveness of inherited loop restoration filter mode decisions across temporally consistent segments.

In some examples, a frame may be identified as an anchor frame or a non-anchor frame in 1202 based on a hierarchical GOP structure. For example, frames occupying leading positions in encoding order within a hierarchical mini-group-of-pictures may be classified as anchor frames, while frames occupying non-leading positions may be classified as non-anchor frames. Performing classification in this manner can include determining whether a frame occupies a non-leading position in the encoding order of a hierarchical mini-group-of-pictures and classifying the frame accordingly. This approach leverages temporal prediction structure and can align anchor frame selection with frames that have higher reference significance in the coding structure.

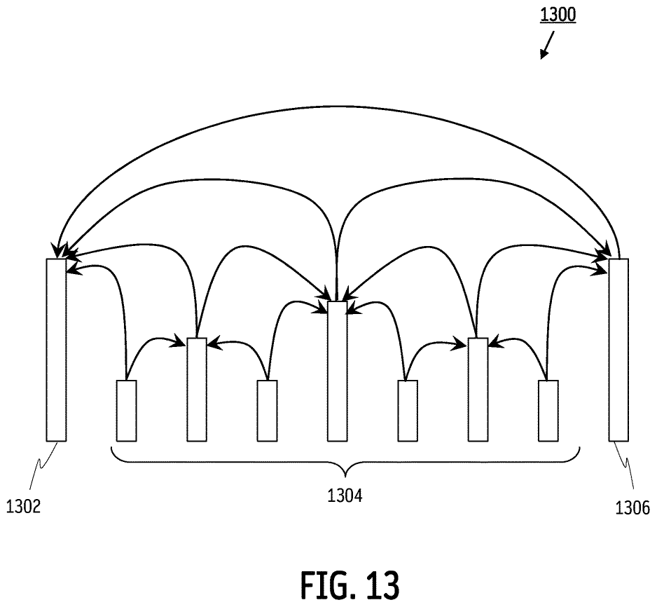

FIG. 13 illustrates a mini-group-of-pictures of size 8 (mini-GOP8) coding structure, according to some examples of the disclosure. Hierarchical coding structure 1300 has a plurality of frames, which are arranged with different temporal prediction relationships. In some examples, the frames positioned at leading locations in encoding order and serving as higher-level references for other frames can be treated as anchor frames, while frames positioned at non-leading locations and primarily predicted with reference to other frames can be treated as non-anchor frames. This type of structure can be used, for example, in a random-access or other hierarchical encoding configuration in which certain frames have greater reference significance than others.

In some examples, frame 1302 of mini-GOP8 coding structure 1300 is treated as an anchor frame. In some examples, frame 1306 of mini-GOP8 coding structure 1300 is treated as an anchor frame. Performing anchor frame classification in this manner can include identifying a first frame in the encoding order of the mini-group-of-pictures as an anchor frame because that frame serves as an initial reference point for other frames in the mini-group-of-pictures. In some examples, the anchor frame can be subjected to a fuller loop restoration filter search, such as a search mode configuration that includes both frame filter mode and restoration-unit filter mode, so that a loop restoration filter mode can be decided for that anchor frame based on rate-distortion considerations.

In some examples, one or more remaining frames of mini-GOP8 coding structure 1300 (e.g., one or more of frames 1304) are treated or classified as non-anchor frames. Performing non-anchor-frame classification in this manner can include determining that a frame occupies a non-leading position in the encoding order of the hierarchical mini-group-of-pictures and, based on that position, classifying the frame as a non-anchor frame. In some examples, these non-anchor frames can inherit a loop restoration filter mode based on a further loop restoration filter mode decided for an encoded anchor frame, rather than repeating a fuller dual-mode search for each of the non-anchor frames.

In some examples, FIG. 13 illustrates one example of how hierarchical prediction structure can be used to distinguish anchor frames from non-anchor frames for purposes of loop restoration filter search. Although mini-GOP8 coding structure 1300 is shown as an example, other hierarchical structures may be used. In some examples, a frame occupying a leading position, such as frame 1302 and frame 1306, in the encoding order within a hierarchical mini-group-of-pictures can be designated as an anchor frame, while one or more frames occupying non-leading positions in the encoding order within that hierarchical mini-group-of-pictures can be designated as non-anchor frames. This classification can reduce loop restoration search complexity for non-anchor frames while preserving fuller mode evaluation for frames having greater reference significance.

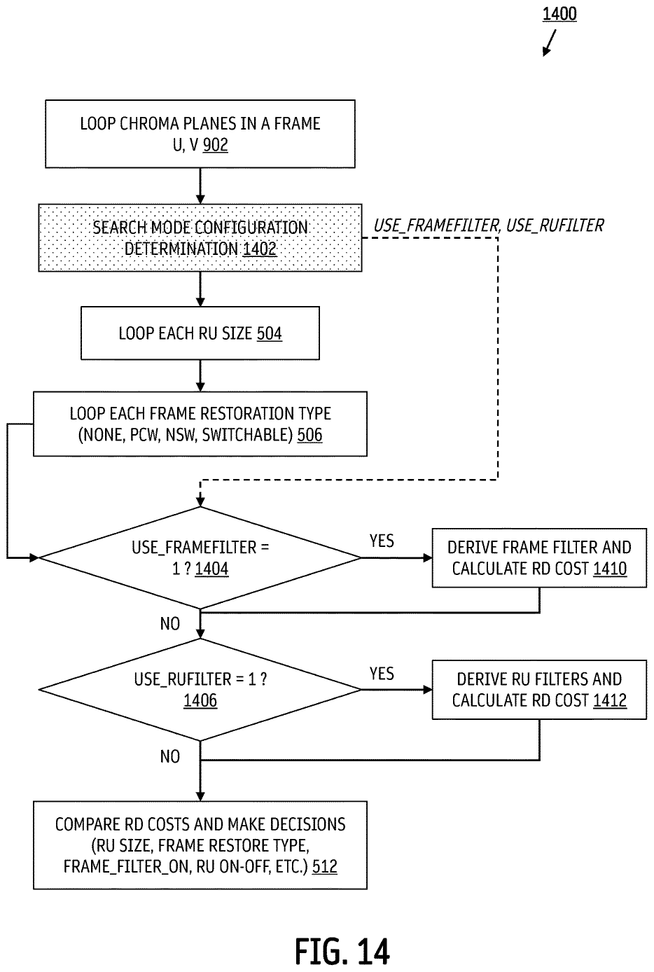

FIG. 14 illustrates loop restoration filter parameter search process 1400 where a filter mode of a reference frame is inherited for non-anchor frames, according to some examples of the disclosure. Process 1400 can correspond to inherit filter mode decision 626 of FIG. 6 and can represent a chroma plane-specific implementation in which a loop restoration filter search mode configuration is set for a non-anchor frame based on a further loop restoration filter mode decided for an encoded anchor frame. In some examples, process 1400 enables a loop restoration filter search for a chroma plane to proceed according to an inherited search mode rather than requiring a fuller dual-mode search for each non-anchor frame.

In 902, loop restoration filter decision part 440 loops chroma planes in a frame, such as U and V planes. Performing the looping in 902 can include processing one or more chroma planes of a current frame on a plane-by-plane basis. In some examples, process 1400 is applied after a frame has been classified for purposes of anchor-frame-based mode inheritance.

In 1402, loop restoration filter decision part 440 determines the search mode configuration. Determining the search mode configuration in 1402 can include determining whether a frame is a non-anchor frame and, based on the frame being the non-anchor frame, setting a loop restoration filter search mode configuration in a loop restoration filter search based on a further loop restoration filter mode decided for an encoded anchor frame. Determining the search mode configuration in 1402 can include determining whether a frame is an anchor frame and, based on the frame being the anchor frame, setting a loop restoration filter search mode configuration in the loop restoration filter search to include a frame filter mode and a restoration-unit filter mode. In some examples, 1402 produces values for USE_FRAMEFILTER and USE_RUFILTER that define the search mode configuration for the frame based on whether the frame is a non-anchor frame or an anchor frame.

In 504, loop restoration filter decision part 440 loops each restoration-unit size, and, in 506, loop restoration filter decision part 440 loops each frame restoration type. Performing 504 and 506 can include evaluating candidate RU sizes and restoration types for the chroma plane while process 1400 is controlled by the search mode configuration produced in 1402. In some examples, candidate restoration types can include none, PCW, NSW, and switchable.

In 1404, loop restoration filter decision part 440 determines whether USE_FRAMEFILTER equals 1. Performing the determination in 1404 can include evaluating whether the search mode configuration set in 1402 enables frame filter mode for the current non-anchor frame. In some examples, when USE_FRAMEFILTER equals 1, process 1400 proceeds to 1410 so that deriving frame filters and calculating RD cost are performed for the chroma plane.

In 1410, loop restoration filter decision part 440 derives frame filters and calculates rate-distortion cost. Performing the derivation in 1410 can include deriving frame-level restoration filters for the chroma plane and determining corresponding rate-distortion costs associated with the use of frame-level filtering. In some examples, performing 1410 corresponds to selecting a frame filter mode for the frame based on the encoded anchor frame using frame filter mode.

In 1406, loop restoration filter decision part 440 determines whether USE_RUFILTER equals 1. Performing the determination in 1406 can include evaluating whether the search mode configuration set in 1402 enables restoration-unit filter mode for the current non-anchor frame. In some examples, when USE_RUFILTER equals 1, process 1400 proceeds to 1412 so that deriving RU filters and calculating RD cost are performed for the chroma plane.

In 1412, loop restoration filter decision part 440 derives RU filters and calculates rate-distortion cost. Performing the derivation in 1412 can include deriving restoration-unit-level filters for restoration units of the chroma plane and determining corresponding rate-distortion costs associated with the use of restoration-unit-level filtering. In some examples, performing 1412 corresponds to selecting a restoration-unit filter mode for the frame based on the encoded anchor frame using restoration-unit filter mode.

In 512, loop restoration filter decision part 440 compares rate-distortion costs and makes one or more decisions for the chroma plane. Performing the comparison in 512 can include selecting a restoration-unit size, selecting a frame restoration type, and making one or more frame_filter_on or RU on-off decisions consistent with the search mode configuration determined in 1402. In some examples, because process 1400 is controlled by USE_FRAMEFILTER and USE_RUFILTER derived from an encoded anchor frame, the loop restoration filter search for the non-anchor frame is narrowed relative to a fuller search that would otherwise enable both modes.

In some examples, process 1400 also reflects behavior for anchor frames even though FIG. 14 emphasizes inheritance for non-anchor frames. For example, when a frame is classified as an anchor frame, a loop restoration filter search mode configuration can include both frame filter mode and restoration-unit filter mode, such as USE_FRAMEFILTER=1 and USE_RUFILTER=1, so that both candidate modes are available for search. By contrast, for a non-anchor frame, process 1400 can inherit a filter mode based on the encoded anchor frame and thereby reduce complexity while leveraging temporal correlation between the anchor frame and the non-anchor frame.

In some examples, process 1400 reflects an observation that temporal correlation exists between an anchor frame and one or more associated non-anchor frames, such that a loop restoration filter mode selected for the anchor frame is likely to remain suitable for the associated non-anchor frames. Accordingly, rather than independently determining a loop restoration filter mode for each non-anchor frame, process 1400 can reuse the mode decision from the encoded anchor frame to guide the loop restoration filter search. This approach can reduce redundant evaluation of candidate modes while maintaining coding efficiency.

In some examples, process 1400 provides a mechanism to reduce computational complexity by selectively omitting portions of the loop restoration filter search for non-anchor frames. For example, when USE_FRAMEFILTER is set to 1 and USE_RUFILTER is set to 0 based on the encoded anchor frame, derive RU filters and calculate RD cost in 1412 may be omitted, and only derive frame filters and calculate RD cost in 1410 may be performed. Conversely, when USE_FRAMEFILTER is set to 0 and USE_RUFILTER is set to 1, derive frame filters and calculate RD cost in 1410 may be omitted, and only derive RU filters and calculate RD cost in 1412 may be performed. In this manner, process 1400 can reduce the search space and associated complexity for non-anchor frames.

In some examples, process 1400 can be particularly beneficial in hardware implementations, where performing both frame-level and restoration-unit-level filter searches for every frame may not be feasible due to resource constraints. By enabling a fuller search for anchor frames and a reduced search for non-anchor frames, process 1400 balances coding efficiency and implementation complexity. This approach can be integrated with other decision mechanisms, such as quantization parameter-based decision or picture color analysis, such that anchor frames are used to determine an appropriate filtering mode and non-anchor frames inherit that decision in a controlled manner.

In some examples, process 1400 may be applied independently to each chroma plane, such that the loop restoration filter search mode configuration for a U plane may be inherited independently from that of a V plane or may be applied jointly to multiple chroma planes depending on implementation. Additionally, although FIG. 14 illustrates inheritance from a latest encoded anchor frame, other variations are possible, such as inheriting from a nearest anchor frame in display order or encoding order, or from a reference frame selected based on prediction relationships. These variations further illustrate flexibility in applying anchor-frame-based loop restoration filter mode inheritance.

### Example Methods for Encoding a Video

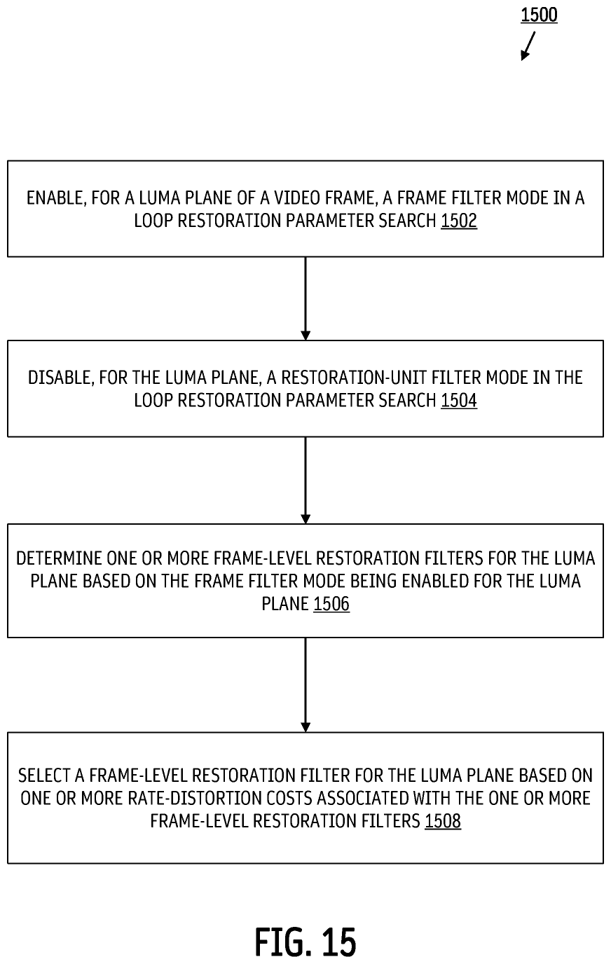

FIG. 15 illustrates a method for encoding a video, according to some examples of the disclosure. Method 1500 can be carried out in loop restoration filter decision part 440 of encoder 102 as described and illustrated in FIGS. 4 and 6.

In 1502, a frame filter mode can be enabled in a loop restoration parameter search or a luma plane of a video frame.

In 1504, a restoration-unit filter mode can be disabled in the loop restoration parameter search for the luma plane.

In 1506, one or more frame-level restoration filters may be determined for the luma plane based on the frame filter mode flag being enabled for the luma plane.

In 1508, a frame-level restoration filter for the luma plane can be selected based on one or more rate-distortion costs associated with the one or more frame-level restoration filters.

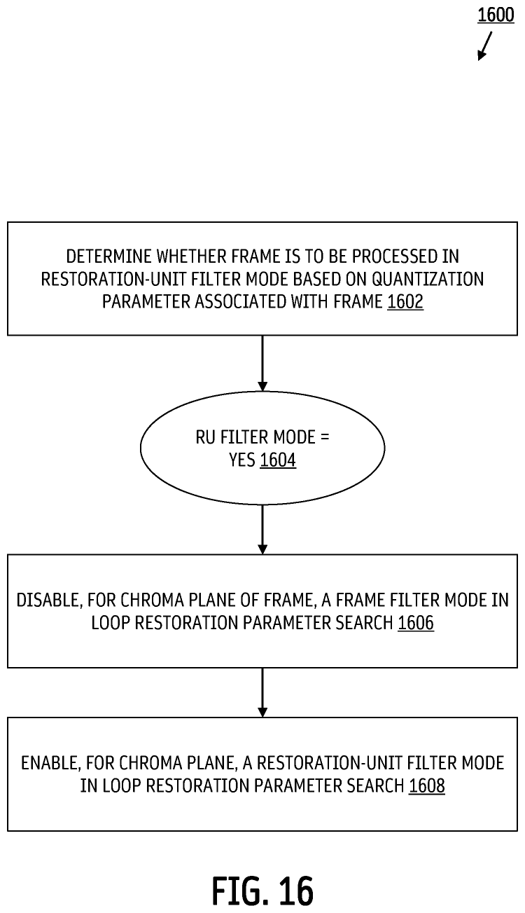

FIG. 16 illustrates a method for encoding a video, according to some examples of the disclosure. Method 1600 can be carried out in loop restoration filter decision part 440 of encoder 102 as described and illustrated in FIGS. 4 and 6.

In 1602, whether a frame is to be processed in a restoration-unit filter mode can be determined based on a quantization parameter associated with the frame.

In 1604, it is determined that the frame is to be processed in the restoration-unit filter mode.

In 1606, a frame filter mode can be disabled in a loop restoration parameter search for a chroma plane of the frame.

In 1608, a restoration-unit filter mode can be enabled in the loop restoration parameter search for the chroma plane.

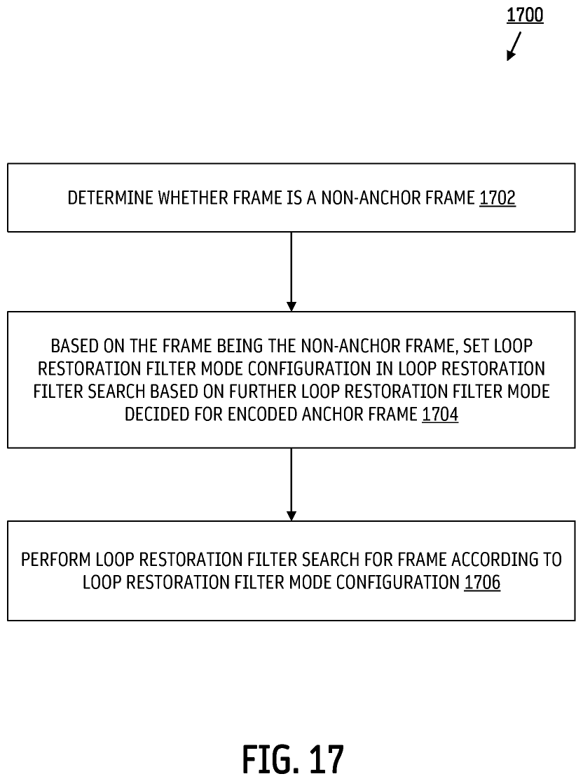

FIG. 17 illustrates method 1700 for encoding a video, according to some examples of the disclosure. Method 1700 can be carried out in loop restoration filter decision part 440 of encoder 102 as described and illustrated in FIGS. 4 and 6.

In 1702, whether a frame is a non-anchor frame is determined.

In 1704, based on the frame being the non-anchor frame, a loop restoration filter search mode configuration in a loop restoration filter search can be set based on a further loop restoration filter mode decided for an encoded anchor frame.

In 1706, the loop restoration filter search can be performed for the frame according to the loop restoration filter mode configuration.

### Exemplary Computing Device

FIG. 18 is a block diagram of an apparatus or a system, e.g., an exemplary computing device 1800, according to some examples of the disclosure. One or more computing devices 1800 may be used to implement the functionalities described with the FIGS. and herein. A number of components are illustrated in FIG. 18 that can be included in computing device 1800, but any one or more of these components may be omitted or duplicated, as suitable for the application. In some examples, some or all of the components included in computing device 1800 may be attached to one or more motherboards. In some examples, some or all of these components are fabricated onto a single system on a chip (SoC) die. Additionally, in various examples, computing device 1800 may not include one or more of the components illustrated in FIG. 18, and computing device 1800 may include interface circuitry for coupling to the one or more components. For example, computing device 1800 may not include a display device 1806, and may include display device interface circuitry (e.g., a connector and driver circuitry) to which a display device 1806 may be coupled. In another set of examples, computing device 1800 may not include audio input device 1818 or audio output device 1808 and may include audio input or output device interface circuitry (e.g., connectors and supporting circuitry) to which an audio input device 1818 or audio output device 1808 may be coupled.

Computing device 1800 may include a processing device 1802 (e.g., one or more processing devices, one or more of the same type of processing device, one or more of different types of processing devices). The processing device 1802 may include processing circuitry or electronic circuitry that processes electronic data from data storage elements (e.g., registers, memory, resistors, capacitors, quantum bit cells) to transform that electronic data into other electronic data that may be stored in registers and/or memory. Examples of processing device 1802 may include a CPU, a GPU, a quantum processor, a machine learning processor, an artificial intelligence processor, a neural-network processor, an artificial intelligence accelerator, an application-specific integrated circuit (ASIC), an analog signal processor, an analog computer, a microprocessor, a digital signal processor, a field-programmable gate array (FPGA), a tensor processing unit (TPU), a data processing unit (DPU), etc.

Computing device 1800 may include a memory 1804, which may itself include one or more memory devices such as volatile memory (e.g., DRAM), nonvolatile memory (e.g., read-only memory (ROM)), high-bandwidth memory (HBM), flash memory, solid-state memory, and/or a hard drive. Memory 1804 includes one or more non-transitory computer-readable storage media. In some examples, memory 1804 may include memory that shares a die with the processing device 1802.

In some examples, memory 1804 includes one or more non-transitory computer-readable media storing instructions executable to perform operations described herein, such as operations illustrated in FIGS. 1-17, process 700 of FIG. 7, process 800 of FIG. 8, process 900 of FIG. 9, process 1100 of FIG. 11, process 1200 of FIG. 12, process 1400 of FIG. 14, method 1500 of FIG. 15, method 1600 of FIG. 16, and method 1700 of FIG. 17. In some examples, memory 1804 includes one or more non-transitory computer-readable media storing instructions executable to perform one or more operations of encoder 102. In some examples, memory 1804 includes one or more non-transitory computer-readable media storing instructions executable to perform one or more operations of loop restoration filter decision part 440. In some examples, memory 1804 includes one or more non-transitory computer-readable media storing instructions executable to perform one or more operations of in-loop filter 228. The instructions stored in memory 1804 may be executed by processing device 1802.

In some examples, memory 1804 may store data, e.g., data structures, binary data, bits, metadata, files, blobs, etc., as described with the FIGS. and herein. Memory 1804 may include one or more non-transitory computer-readable media storing one or more of: input frames to the encoder (e.g., video frames 104), intermediate data structures computed by the encoder, bitstream generated by the encoder (encoded bitstream 180), bitstream received by a decoder (encoded bitstream 180), intermediate data structures computed by the decoder, and reconstructed frames generated by the decoder. Memory 1804 may include decoded picture buffer 232. Memory 1804 may include one or more non-transitory computer-readable media storing one or more of: data received and/or data generated by operations illustrated in FIGS. 1-17.

In some examples, computing device 1800 may include a communication device 1812 (e.g., one or more communication devices). For example, communication device 1812 may be configured for managing wired and/or wireless communications for the transfer of data to and from computing device 1800. The term “wireless” and its derivatives may be used to describe circuits, devices, systems, methods, techniques, communications channels, etc., that may communicate data through the use of modulated electromagnetic radiation through a non-solid medium. The term does not imply that the associated devices do not contain any wires, although in some examples they might not. Communication device 1812 may implement any of a number of wireless standards or protocols. Communication device 1812 may operate in accordance with other wireless protocols in other examples. Computing device 1800 may include an antenna 1822 to facilitate wireless communications and/or to receive other wireless communications (such as radio frequency transmissions). Computing device 1800 may include receiver circuits and/or transmitter circuits. In some examples, communication device 1812 may manage wired communications, such as electrical, optical, or any other suitable communication protocols (e.g., Ethernet). As noted above, communication device 1812 may include multiple communication chips. For instance, a first communication device 1812 may be dedicated to shorter-range wireless communications such as Wi-Fi or Bluetooth, and a second communication device 1812 may be dedicated to longer-range wireless communications. In some examples, a first communication device 1812 may be dedicated to wireless communications, and a second communication device 1812 may be dedicated to wired communications.

Computing device 1800 may include power source/power circuitry 1814. Power source/power circuitry 1814 may include one or more energy storage devices (e.g., batteries or capacitors) and/or circuitry for coupling components of computing device 1800 to an energy source separate from computing device 1800 (e.g., DC power, AC power, etc.).

Computing device 1800 may include display device 1806 (or corresponding interface circuitry, as discussed above). Display device 1806 may include any visual indicators, such as a heads-up display, a computer monitor, a projector, a touchscreen display, a liquid crystal display (LCD), a light-emitting diode display, or a flat panel display, for example.

Computing device 1800 may include audio output device 1808 (or corresponding interface circuitry, as discussed above). Audio output device 1808 may include any device that generates an audible indicator, such as speakers, headsets, or earbuds, for example.

Computing device 1800 may include audio input device 1818 (or corresponding interface circuitry, as discussed above). Audio input device 1818 may include any device that generates a signal representative of a sound, such as microphones, microphone arrays, or digital instruments (e.g., instruments having a musical instrument digital interface (MIDI) output).

Computing device 1800 may include global positioning system (GPS) device 1816 (or corresponding interface circuitry, as discussed above). GPS device 1816 may be in communication with a satellite-based system and may receive a location of computing device 1800, as known in the art.

Computing device 1800 may include sensor 1830 (or one or more sensors). Computing device 1800 may include corresponding interface circuitry, as discussed above). Sensor 1830 may sense physical phenomena and translate the physical phenomena into electrical signals that can be processed by, e.g., processing device 1802. Examples of sensor 1830 may include: capacitive sensor, inductive sensor, resistive sensor, electromagnetic field sensor, light sensor, camera, imager, microphone, pressure sensor, temperature sensor, vibrational sensor, accelerometer, gyroscope, strain sensor, moisture sensor, humidity sensor, distance sensor, range sensor, time-of-flight sensor, pH sensor, particle sensor, air quality sensor, chemical sensor, gas sensor, biosensor, ultrasound sensor, a scanner, etc.

Computing device 1800 may include another output device 1810 (or corresponding interface circuitry, as discussed above). Examples of the other output device 1810 may include an audio codec, a video codec, a printer, a wired or wireless transmitter for providing information to other devices, haptic output device, gas output device, vibrational output device, lighting output device, home automation controller, or an additional storage device.

Computing device 1800 may include another input device 1820 (or corresponding interface circuitry, as discussed above). Examples of the other input device 1820 may include an accelerometer, a gyroscope, a compass, an image capture device, a keyboard, a cursor control device such as a mouse, a stylus, a touchpad, a bar code reader, a Quick Response (QR) code reader, any sensor, or a radio frequency identification (RFID) reader.

Computing device 1800 may have any desired form factor, such as a handheld or mobile computer system (e.g., a cell phone, a smartphone, a mobile Internet device, a music player, a tablet computer, a laptop computer, a netbook computer, a personal digital assistant (PDA), an ultramobile personal computer, a remote control, a wearable device, headgear, eyewear, footwear, electronic clothing, etc.), a desktop computer system, a server or other networked computing component, a printer, a scanner, a monitor, a set-top box, an entertainment control unit, a vehicle control unit, a digital camera, a digital video recorder, an Internet-of-Things device, or a wearable computer system. In some examples, computing device 1800 may be any other electronic device that processes data.

### SELECT EXAMPLES

Example 1 provides an apparatus, including one or more processors; and one or more non-transitory computer-readable media storing instructions that, when executed by the one or more processors, cause the one or more processors to perform operations including enabling, for a luma plane of a video frame, a frame filter mode in a loop restoration parameter search; disabling, for the luma plane, a restoration-unit filter mode in the loop restoration parameter search; determining one or more frame-level restoration filters for the luma plane based on the frame filter mode being enabled for the luma plane; and selecting a frame-level restoration filter for the luma plane based on one or more rate-distortion costs associated with the one or more frame-level restoration filters.

Example 2 provides the apparatus of example 1, where the operations further include determining the one or more rate-distortion costs associated with the one or more frame-level restoration filters by applying the one or more frame-level restoration filters onto restoration units of the luma plane.

Example 3 provides the apparatus of example 1 or 2, where the one or more frame-level restoration filters include one or more non-separable Wiener filters.

Example 4 provides the apparatus of any one of examples 1-3, where the one or more frame-level restoration filters include one or more classes of filters specified for the luma plane.

Example 5 provides the apparatus of any one of examples 1-4, where determining the one or more frame-level restoration filters includes determining one or more frame-level filters selected for a reference frame of the video frame.

Example 6 provides the apparatus of any one of examples 1-5, where determining the one or more frame-level restoration filters includes determining the one or more frame-level restoration filters for a plurality of candidate restoration-unit sizes.

Example 7 provides the apparatus of any one of examples 1-6, where the operations further include skipping a restoration-unit parameter search for the luma plane based on the restoration-unit filter mode being disabled.

Example 8 provides an apparatus, including one or more processors; and one or more non-transitory computer-readable media storing instructions that, when executed by the one or more processors, cause the one or more processors to perform operations including determining whether a frame is to be processed in a restoration-unit filter mode based on a quantization parameter associated with the frame; and based on determining that the frame is to be processed in the restoration-unit filter mode: disabling, for a chroma plane of the frame, a frame filter mode in a loop restoration parameter search; and enabling, for the chroma plane, the restoration-unit filter mode in the loop restoration parameter search.

Example 9 provides the apparatus of example 8, where the operations further include determining whether the chroma plane meets a diversity condition; and based on the chroma plane meeting the diversity condition: disabling, for the chroma plane of the frame, the frame filter mode; and enabling, for the chroma plane, the restoration-unit filter mode.

Example 10 provides the apparatus of example 9, where determining whether the chroma plane meets the diversity condition includes generating a variance histogram based on block variances for blocks of the chroma plane.

Example 11 provides the apparatus of example 10, where the block variances are calculated using absolute differences of pixel values in the blocks.

Example 12 provides the apparatus of example 10 or 11, where the blocks have a size corresponding to a superblock size used in encoding the frame.

Example 13 provides the apparatus of any one of examples 10-12, where determining whether the chroma plane meets the diversity condition further includes determining a diversity metric based on the variance histogram.

Example 14 provides the apparatus of example 13, where determining the diversity metric includes determining a count of histogram bins of the variance histogram associated with a block-percentage range and a further count of histogram bins of the variance histogram associated with a further block-percentage range; determining a value of a zero-variance histogram bin of the variance histogram; and computing the diversity metric based on the count, the further count, and the value.

Example 15 provides the apparatus of examples 9-14, where the operations further include, based on the chroma plane not meeting the diversity condition: enabling, for the chroma plane of the frame, the frame filter mode; and disabling, for the chroma plane, the restoration-unit filter mode.

Example 16 provides the apparatus of any one of examples 8-15, where determining whether the frame is to be processed in the restoration-unit filter mode based on the quantization parameter associated with the frame includes comparing the quantization parameter against a threshold, or determining whether the quantization parameter falls within a range.

Example 17 provides the apparatus of any one of examples 8-16, where determining that the frame is to be processed in the restoration-unit filter mode includes determining that the quantization parameter is below a threshold.

Example 18 provides an apparatus, including one or more processors; and one or more non-transitory computer-readable media storing instructions that, when executed by the one or more processors, cause the one or more processors to perform operations including determining whether a frame is a non-anchor frame; based on the frame being the non-anchor frame, setting a loop restoration filter search mode configuration in a loop restoration filter search based on a further loop restoration filter mode decided for an encoded anchor frame; and performing the loop restoration filter search for the frame according to the loop restoration filter search mode configuration.

Example 19 provides the apparatus of example 18, where determining whether the frame is the non-anchor frame includes determining whether the frame is an inter-frame.

Example 20 provides the apparatus of example 18 or 19, where determining whether the frame is the non-anchor frame includes determining whether the frame occupies a non-leading position in an encoding order of a hierarchical mini-group-of-pictures.

Example 21 provides the apparatus of any one of examples 18-20, where determining whether the frame is the non-anchor frame includes identifying one or more anchor frames according to a periodic selection process and classifying one or more remaining frames as one or more non-anchor frames.

Example 22 provides the apparatus of any one of examples 18-21, where determining whether the frame is the non-anchor frame includes detecting one or more scene-change frames and classifying one or more frames between the one or more scene-change frames as one or more non-anchor frames.

Example 23 provides the apparatus of any one of examples 18-22, where setting the loop restoration filter search mode configuration in the loop restoration filter search based on the further loop restoration filter mode decided for the encoded anchor frame includes selecting a frame filter mode for the frame based on the encoded anchor frame using the frame filter mode.

Example 24 provides the apparatus of any one of examples 18-23, where setting the loop restoration filter search mode configuration in the loop restoration filter search based on the further loop restoration filter mode decided for the encoded anchor frame includes selecting a restoration-unit filter mode for the frame based on the encoded anchor frame using the restoration-unit filter mode.

Example 25 provides the apparatus of any one of examples 18-24, where the operations further include determining whether the frame is an anchor frame; and based on the frame being the anchor frame, setting the loop restoration filter search mode configuration to include a frame filter mode and a restoration-unit filter mode.

Example 26 provides one or more non-transitory computer-readable media storing instructions that, when executed by one or more processors, cause the one or more processors to perform operations including enabling, for a luma plane of a video frame, a frame filter mode in a loop restoration parameter search; disabling, for the luma plane, a restoration-unit filter mode in the loop restoration parameter search; determining one or more frame-level restoration filters for the luma plane based on the frame filter mode being enabled for the luma plane; and selecting a frame-level restoration filter for the luma plane based on one or more rate-distortion costs associated with the one or more frame-level restoration filters.

Example 27 provides the one or more non-transitory computer-readable media of example 26, where the operations further include determining the one or more rate-distortion costs associated with the one or more frame-level restoration filters by applying the one or more frame-level restoration filters onto restoration units of the luma plane.

Example 28 provides the one or more non-transitory computer-readable media of example 26 or 27, where the one or more frame-level restoration filters include one or more non-separable Wiener filters.

Example 29 provides the one or more non-transitory computer-readable media of any one of examples 26-28, where the one or more frame-level restoration filters include one or more classes of filters specified for the luma plane.

Example 30 provides the one or more non-transitory computer-readable media of any one of examples 26-29, where determining the one or more frame-level restoration filters includes determining one or more frame-level filters selected for a reference frame of the video frame.

Example 31 provides the one or more non-transitory computer-readable media of any one of examples 26-30, where determining the one or more frame-level restoration filters includes determining the one or more frame-level restoration filters for a plurality of candidate restoration-unit sizes.

Example 32 provides the one or more non-transitory computer-readable media of any one of examples 26-31, where the operations further include skipping a restoration-unit parameter search for the luma plane based on the restoration-unit filter mode being disabled.

Example 33 provides one or more non-transitory computer-readable media storing instructions that, when executed by one or more processors, cause the one or more processors to perform operations including determining whether a frame is to be processed in a restoration-unit filter mode based on a quantization parameter associated with the frame; and based on determining that the frame is to be processed in the restoration-unit filter mode: disabling, for a chroma plane of the frame, a frame filter mode in a loop restoration parameter search; and enabling, for the chroma plane, the restoration-unit filter mode in the loop restoration parameter search.

Example 34 provides the one or more non-transitory computer-readable media of example 33, where the operations further include determining whether the chroma plane meets a diversity condition; and based on the chroma plane meeting the diversity condition: disabling, for the chroma plane of the frame, the frame filter mode; and enabling, for the chroma plane, the restoration-unit filter mode.

Example 35 provides the one or more non-transitory computer-readable media of example 34, where determining whether the chroma plane meets the diversity condition includes generating a variance histogram based on block variances for blocks of the chroma plane.

Example 36 provides the one or more non-transitory computer-readable media of example 35, where the block variances are calculated using absolute differences of pixel values in the blocks.

Example 37 provides the one or more non-transitory computer-readable media of example 35 or 36, where the blocks have a size corresponding to a superblock size used in encoding the frame.

Example 38 provides the one or more non-transitory computer-readable media of any one of examples 35-37, where determining whether the chroma plane meets the diversity condition further includes determining a diversity metric based on the variance histogram.

Example 39 provides the one or more non-transitory computer-readable media of example 38, where determining the diversity metric includes determining a count of histogram bins of the variance histogram associated with a block-percentage range and a further count of histogram bins of the variance histogram associated with a further block-percentage range; determining a value of a zero-variance histogram bin of the variance histogram; and computing the diversity metric based on the count, the further count, and the value.

Example 40 provides the one or more non-transitory computer-readable media of examples 34-39, where the operations further include, based on the chroma plane not meeting the diversity condition: enabling, for the chroma plane of the frame, the frame filter mode; and disabling, for the chroma plane, the restoration-unit filter mode.

Example 41 provides the one or more non-transitory computer-readable media of any one of examples 33-40, where determining whether the frame is to be processed in the restoration-unit filter mode based on the quantization parameter associated with the frame includes comparing the quantization parameter against a threshold, or determining whether the quantization parameter falls within a range.

Example 42 provides the one or more non-transitory computer-readable media of any one of examples 33-41, where determining that the frame is to be processed in the restoration-unit filter mode includes determining that the quantization parameter is below a threshold.

Example 43 provides one or more non-transitory computer-readable media storing instructions that, when executed by one or more processors, cause the one or more processors to perform operations including determining whether a frame is a non-anchor frame; based on the frame being the non-anchor frame, setting a loop restoration filter search mode configuration in a loop restoration filter search based on a further loop restoration filter mode decided for an encoded anchor frame; and performing the loop restoration filter search for the frame according to the loop restoration filter search mode configuration.

Example 44 provides the one or more non-transitory computer-readable media of example 43, where determining whether the frame is the non-anchor frame includes determining whether the frame is an inter-frame.

Example 45 provides the one or more non-transitory computer-readable media of example 43 or 44, where determining whether the frame is the non-anchor frame includes determining whether the frame occupies a non-leading position in an encoding order of a hierarchical mini-group-of-pictures.

Example 46 provides the one or more non-transitory computer-readable media of any one of examples 43-45, where determining whether the frame is the non-anchor frame includes identifying one or more anchor frames according to a periodic selection process and classifying one or more remaining frames as one or more non-anchor frames.

Example 47 provides the one or more non-transitory computer-readable media of any one of examples 43-46, where determining whether the frame is the non-anchor frame includes detecting one or more scene-change frames and classifying one or more frames between the one or more scene-change frames as one or more non-anchor frames.

Example 48 provides the one or more non-transitory computer-readable media of any one of examples 43-47, where setting the loop restoration filter search mode configuration in the loop restoration filter search based on the further loop restoration filter mode decided for the encoded anchor frame includes selecting a frame filter mode for the frame based on the encoded anchor frame using the frame filter mode.

Example 49 provides the one or more non-transitory computer-readable media of any one of examples 43-48, where setting the loop restoration filter search mode configuration in the loop restoration filter search based on the further loop restoration filter mode decided for the encoded anchor frame includes selecting a restoration-unit filter mode for the frame based on the encoded anchor frame using the restoration-unit filter mode.

Example 50 provides the one or more non-transitory computer-readable media of any one of examples 43-49, where the operations further include determining whether the frame is an anchor frame; and based on the frame being the anchor frame, setting the loop restoration filter search mode configuration to include a frame filter mode and a restoration-unit filter mode.

Example 51 provides a method, including enabling, for a luma plane of a video frame, a frame filter mode in a loop restoration parameter search; disabling, for the luma plane, a restoration-unit filter mode in the loop restoration parameter search; determining one or more frame-level restoration filters for the luma plane based on the frame filter mode being enabled for the luma plane; and selecting a frame-level restoration filter for the luma plane based on one or more rate-distortion costs associated with the one or more frame-level restoration filters.

Example 52 provides the method of example 51, further including determining the one or more rate-distortion costs associated with the one or more frame-level restoration filters by applying the one or more frame-level restoration filters onto restoration units of the luma plane.

Example 53 provides the method of example 51 or 52, where the one or more frame-level restoration filters include one or more non-separable Wiener filters.

Example 54 provides the method of any one of examples 51-53, where the one or more frame-level restoration filters include one or more classes of filters specified for the luma plane.

Example 55 provides the method of any one of examples 51-54, where determining the one or more frame-level restoration filters includes determining one or more frame-level filters selected for a reference frame of the video frame.

Example 56 provides the method of any one of examples 51-55, where determining the one or more frame-level restoration filters includes determining the one or more frame-level restoration filters for a plurality of candidate restoration-unit sizes.

Example 57 provides the method of any one of examples 51-56, further including skipping a restoration-unit parameter search for the luma plane based on the restoration-unit filter mode being disabled.

Example 58 provides a method, including determining whether a frame is to be processed in a restoration-unit filter mode based on a quantization parameter associated with the frame; and, based on determining that the frame is to be processed in the restoration-unit filter mode: disabling, for a chroma plane of the frame, a frame filter mode in a loop restoration parameter search; and enabling, for the chroma plane, the restoration-unit filter mode in the loop restoration parameter search.

Example 59 provides the method of example 58, further including determining whether the chroma plane meets a diversity condition; and, based on the chroma plane meeting the diversity condition: disabling, for the chroma plane of the frame, the frame filter mode; and enabling, for the chroma plane, the restoration-unit filter mode.

Example 60 provides the method of example 59, where determining whether the chroma plane meets the diversity condition includes generating a variance histogram based on block variances for blocks of the chroma plane.

Example 61 provides the method of example 60, where the block variances are calculated using absolute differences of pixel values in the blocks.

Example 62 provides the method of example 60 or 61, where the blocks have a size corresponding to a superblock size used in encoding the frame.

Example 63 provides the method of any one of examples 60-62, further including determining a diversity metric based on the variance histogram.

Example 64 provides the method of example 63, where determining the diversity metric includes determining a count of histogram bins of the variance histogram associated with a block-percentage range and a further count of histogram bins of the variance histogram associated with a further block-percentage range; determining a value of a zero-variance histogram bin of the variance histogram; and computing the diversity metric based on the count, the further count, and the value.

Example 65 provides the method of examples 59-64, further including, based on the chroma plane not meeting the diversity condition: enabling, for the chroma plane of the frame, the frame filter mode; and disabling, for the chroma plane, the restoration-unit filter mode.

Example 66 provides the method of any one of examples 58-65, where determining whether the frame is to be processed in the restoration-unit filter mode based on the quantization parameter associated with the frame includes comparing the quantization parameter against a threshold, or determining whether the quantization parameter falls within a range.

Example 67 provides the method of any one of examples 58-66, where determining that the frame is to be processed in the restoration-unit filter mode includes determining that the quantization parameter is below a threshold.

Example 68 provides a method, including determining whether a frame is a non-anchor frame; based on the frame being the non-anchor frame, setting a loop restoration filter search mode configuration in a loop restoration filter search based on a further loop restoration filter mode decided for an encoded anchor frame; and performing the loop restoration filter search for the frame according to the loop restoration filter search mode configuration.

Example 69 provides the method of example 68, where determining whether the frame is the non-anchor frame includes determining whether the frame is an inter-frame.

Example 70 provides the method of example 68 or 69, where determining whether the frame is the non-anchor frame includes determining whether the frame occupies a non-leading position in an encoding order of a hierarchical mini-group-of-pictures.

Example 71 provides the method of any one of examples 68-70, where determining whether the frame is the non-anchor frame includes identifying one or more anchor frames according to a periodic selection process and classifying one or more remaining frames as one or more non-anchor frames.

Example 72 provides the method of any one of examples 68-71, where determining whether the frame is the non-anchor frame includes detecting one or more scene-change frames and classifying one or more frames between the one or more scene-change frames as one or more non-anchor frames.

Example 73 provides the method of any one of examples 68-72, where setting the loop restoration filter search mode configuration in the loop restoration filter search based on the further loop restoration filter mode decided for the encoded anchor frame includes selecting a frame filter mode for the frame based on the encoded anchor frame using the frame filter mode.

Example 74 provides the method of any one of examples 68-73, where setting the loop restoration filter search mode configuration in the loop restoration filter search based on the further loop restoration filter mode decided for the encoded anchor frame includes selecting a restoration-unit filter mode for the frame based on the encoded anchor frame using the restoration-unit filter mode.

Example 75 provides the method of any one of examples 68-74, further including determining whether the frame is an anchor frame; and based on the frame being the anchor frame, setting the loop restoration filter search mode configuration to include a frame filter mode and a restoration-unit filter mode.

Example A provides an encoder to generate an encoded bitstream using operations described herein.

Example B provides an encoder to perform any one of the methods provided in examples 51-75 and methods/processes described herein.

Example C provides a loop restoration filter decision part as described herein.

### VARIATIONS AND REMARKS

One or more functionalities of loop restoration filter decision part 440 and encoder 102 can be implemented as software instructions encoded in non-transitory computer-readable media, hardware logic or circuits, or both.

Although the operations of the example method shown in and described with reference to FIGS. 1-18 are illustrated as occurring once each and in a particular order, it will be recognized that some operations may be performed in any suitable order and repeated as desired. Additionally, one or more operations may be performed in parallel. Furthermore, the operations illustrated in FIGS. 1-18 or other FIGS. may be combined or may include more or fewer details than described.

The above description of illustrated implementations of the disclosure, including what is described in the Abstract, is not intended to be exhaustive or to limit the disclosure to the precise forms disclosed. While specific implementations of, and examples for, the disclosure are described herein for illustrative purposes, various equivalent modifications are possible within the scope of the disclosure, as those skilled in the relevant art will recognize. These modifications may be made to the disclosure in light of the above detailed description.

For purposes of explanation, specific numbers, materials, and configurations are set forth in order to provide a thorough understanding of the illustrative implementations. However, it will be apparent to one skilled in the art that the present disclosure may be practiced without the specific details and/or that the present disclosure may be practiced with only some of the described aspects. In other instances, well-known features are omitted or simplified in order not to obscure the illustrative implementations.

Further, references are made to the accompanying drawings that form a part hereof, and in which are shown, by way of illustration, examples that may be practiced. It is to be understood that other examples may be utilized, and structural or logical changes may be made without departing from the scope of the present disclosure. Therefore, the following detailed description is not to be taken in a limiting sense.

Various operations may be described as multiple discrete actions or operations in turn, in a manner that is most helpful in understanding the disclosed subject matter. However, the order of description should not be construed as to imply that these operations are necessarily order-dependent. In particular, these operations may not be performed in the order of presentation. Operations described may be performed in a different order from the described example. Various additional operations may be performed or described operations may be omitted in additional examples.

For the purposes of the present disclosure, the phrase “A or B” or the phrase “A and/or B” means (A), (B), or (A and B). For the purposes of the present disclosure, the phrase “A, B, or C” or the phrase “A, B, and/or C” means (A), (B), (C), (A and B), (A and C), (B and C), or (A, B, and C). For the purposes of the present disclosure, the phrase “one or more of A, B, and C”, the phrase “at least one of A, B, and C”, or the phrase “at least one or more of A, B, and C” means (A), (B), (C), (A and B), (A and C), (B and C), or (A, B, and C). The term “between,” when used with reference to measurement ranges, is inclusive of the ends of the measurement ranges.

For the purposes of the present disclosure, “A is less than or equal to a first threshold” is equivalent to “A is less than a second threshold” provided that the first threshold and the second threshold are set in a manner so that both statements result in the same logical outcome for any value of A. For the purposes of the present disclosure, “B is greater than a first threshold” is equivalent to “B is greater than or equal to a second threshold” provided that the first threshold and the second threshold are set in a manner so that both statements result in the same logical outcome for any value of B.

The description uses the phrases “in an example” or “in examples,” which may each refer to one or more of the same or different examples. The terms “comprising,” “including,” “having,” and the like, as used with respect to examples of the present disclosure, are synonymous. The disclosure may use perspective-based descriptions such as “above,” “below,” “top,” “bottom,” and “side” to explain various features of the drawings, but these terms are simply for ease of discussion, and do not imply a desired or required orientation. The accompanying drawings are not necessarily drawn to scale. Unless otherwise specified, the use of the ordinal adjectives “first,” “second,” and “third,” etc., to describe a common object, merely indicates that different instances of like objects are being referred to and are not intended to imply that the objects so described must be in a given sequence, either temporally, spatially, in ranking or in any other manner.

In the following detailed description, various aspects of the illustrative implementations will be described using terms commonly employed by those skilled in the art to convey the substance of their work to others skilled in the art.

The terms “substantially,” “close,” “approximately,” “near,” and “about,” generally refer to being within +/−20% of a target value as described herein or as known in the art. Similarly, terms indicating orientation of various elements, e.g., “coplanar,” “perpendicular,” “orthogonal,” “parallel,” or any other angle between the elements, generally refer to being within +/−5-20% of a target value as described herein or as known in the art.

In addition, the terms “comprise,” “comprising,” “include,” “including,” “have,” “having” or any other variation thereof, are intended to cover a non-exclusive inclusion. For example, a method, process, or device, that comprises a list of elements is not necessarily limited to only those elements but may include other elements not expressly listed or inherent to such method, process, or device. Also, the term “or” refers to an inclusive “or” and not to an exclusive “or.”

The systems, methods and devices of this disclosure each have several innovative aspects, no single one of which is solely responsible for all desirable attributes disclosed herein. Details of one or more implementations of the subject matter described in this specification are set forth in the description and the accompanying drawings.

What is claimed is:

1. An apparatus, comprising:
one or more processors; and
one or more non-transitory computer-readable media storing instructions that, when executed by the one or more processors, cause the one or more processors to perform operations comprising:
determining whether a frame is to be processed in a restoration-unit filter mode based on a quantization parameter associated with the frame; and
based on determining that the frame is to be processed in the restoration-unit filter mode:
disabling, for a chroma plane of the frame, a frame filter mode in a loop restoration parameter search; and
enabling, for the chroma plane, the restoration-unit filter mode in the loop restoration parameter search.

2. The apparatus of claim 1, wherein the operations further comprise:
determining whether the chroma plane meets a diversity condition; and
based on the chroma plane meeting the diversity condition:
disabling, for the chroma plane of the frame, the frame filter mode; and
enabling, for the chroma plane, the restoration-unit filter mode.

3. The apparatus of claim 2, wherein determining whether the chroma plane meets the diversity condition comprises:
generating a variance histogram based on block variances for blocks of the chroma plane.

4. The apparatus of claim 3, wherein the block variances are calculated using absolute differences of pixel values in the blocks.

5. The apparatus of claim 3, wherein the blocks have a size corresponding to a superblock size used in encoding the frame.

6. The apparatus of claim 3, wherein determining whether the chroma plane meets the diversity condition further comprises:
determining a diversity metric based on the variance histogram.

7. The apparatus of claim 6, wherein determining the diversity metric comprises:
determining a count of histogram bins of the variance histogram associated with a block-percentage range and a further count of histogram bins of the variance histogram associated with a further block-percentage range;
determining a value of a zero-variance histogram bin of the variance histogram; and
computing the diversity metric based on the count, the further count, and the value.

8. The apparatus of claim 2, wherein the operations further comprise:
based on the chroma plane not meeting the diversity condition:
enabling, for the chroma plane of the frame, the frame filter mode; and
disabling, for the chroma plane, the restoration-unit filter mode.

9. The apparatus of claim 1, wherein determining whether the frame is to be processed in the restoration-unit filter mode based on the quantization parameter associated with the frame comprises comparing the quantization parameter against a threshold, or determining whether the quantization parameter falls within a range.

10. The apparatus of claim 1, wherein determining that the frame is to be processed in the restoration-unit filter mode comprises determining that the quantization parameter is below a threshold.

11. One or more non-transitory computer-readable media storing instructions that, when executed by one or more processors, cause the one or more processors to perform operations comprising:
determining whether a frame is to be processed in a restoration-unit filter mode based on a quantization parameter associated with the frame; and
based on determining that the frame is to be processed in the restoration-unit filter mode:
disabling, for a chroma plane of the frame, a frame filter mode in a loop restoration parameter search; and
enabling, for the chroma plane, the restoration-unit filter mode in the loop restoration parameter search.

12. The one or more non-transitory computer-readable media of claim 11, wherein the operations further comprise:
determining whether the chroma plane meets a diversity condition; and
based on the chroma plane meeting the diversity condition:
disabling, for the chroma plane of the frame, the frame filter mode; and
enabling, for the chroma plane, the restoration-unit filter mode.

13. The one or more non-transitory computer-readable media of claim 12, wherein determining whether the chroma plane meets the diversity condition comprises:
generating a variance histogram based on block variances for blocks of the chroma plane.

14. The one or more non-transitory computer-readable media of claim 13, wherein the block variances are calculated using absolute differences of pixel values in the blocks.

15. The one or more non-transitory computer-readable media of claim 13, wherein the blocks have a size corresponding to a superblock size used in encoding the frame.

16. The one or more non-transitory computer-readable media of claim 13, wherein determining whether the chroma plane meets the diversity condition further comprises:
determining a diversity metric based on the variance histogram.

17. The one or more non-transitory computer-readable media of claim 16, wherein determining the diversity metric comprises:
determining a count of histogram bins of the variance histogram associated with a block-percentage range and a further count of histogram bins of the variance histogram associated with a further block-percentage range;
determining a value of a zero-variance histogram bin of the variance histogram; and
computing the diversity metric based on the count, the further count, and the value.

18. The one or more non-transitory computer-readable media of claim 12, wherein the operations further comprise:
based on the chroma plane not meeting the diversity condition:
enabling, for the chroma plane of the frame, the frame filter mode; and
disabling, for the chroma plane, the restoration-unit filter mode.

19. A method, comprising:
determining whether a frame is to be processed in a restoration-unit filter mode based on a quantization parameter associated with the frame; and
based on determining that the frame is to be processed in the restoration-unit filter mode:
disabling, for a chroma plane of the frame, a frame filter mode in a loop restoration parameter search; and
enabling, for the chroma plane, the restoration-unit filter mode in the loop restoration parameter search.

20. The method of claim 19, wherein determining whether the frame is to be processed in the restoration-unit filter mode based on the quantization parameter associated with the frame comprises comparing the quantization parameter against a threshold, or determining whether the quantization parameter falls within a range.
